(19) United States
(12) Patent Application Publication
(10) Pub. No.: US 2024/0028279 A1
(43) Pub. Date: Jan. 25, 2024

(54) INFORMATION PROCESSING APPARATUS, METHOD OF CONTROLLING INFORMATION PROCESSING APPARATUS, IMAGE FORMING APPARATUS, METHOD OF CONTROLLING IMAGE FORMING APPARATUS, STORAGE MEDIUM, AND IMAGE FORMING SYSTEM

(71) Applicant: CANON KABUSHIKI KAISHA, Tokyo (JP)

(72) Inventor: Yuki Inoue, Kanagawa (JP)

(21) Appl. No.: 18/223,633

(22) Filed: Jul. 19, 2023

(30) Foreign Application Priority Data
Jul. 25, 2022 (JP) 2022-118175

(51) Int. Cl. G06F 3/12

(52) U.S. Cl. CPC G06F 3/126; G06F 3/1217

(57) ABSTRACT

An information processing apparatus that can communicate with an image forming apparatus, includes: at least one memory and at least one processor and/or at least one circuit which function as: a reception unit configured to receive printing setting information used for printing processing of a current printing job that is currently running in the image forming apparatus; an obtainment unit configured to obtain a subsequent printing job registered on a printing queue; and a control unit configured to transmit a subsequent printing job, without a printing processing start command and printing setting information, corresponding to the obtained subsequent printing job, to the image forming apparatus in a case where it is possible to perform continuous printing processing in the image forming apparatus based on printing setting information on the received current printing job and printing setting information on the obtained subsequent printing job.

### BACKGROUND OF THE DISCLOSURE

### Field of the Disclosure

The present disclosure relates to a technique to perform continuous feeding processing between printing jobs.

### Description of the Related Art

There has been demanded improvement in the printing processing efficiency. Japanese Patent Laid-Open No. 2011-048489 (hereinafter, referred to as Document 1) discloses a technique to improve the printing processing efficiency in continuous printing in a case where the same printing setting is applied. Specifically, it is a technique in which control information on an immediately preceding printing job is stored, and if it is determined in the next printing job generation that the same printing setting is applied, only image data information is generated without generating printing setting information on the printing job.

Additionally, there has been known processing (hereinafter, referred to as “continuous feeding processing”) for a case of printing plural pages during the same printing job by an image forming apparatus, in which a printing time between the pages is shortened by starting sheet feeding of the next page during printing processing in a case where it is determined that the same printing setting is applied.

Including Document 1, since the continuous feeding processing between printing jobs is not implemented, the shortening of the printing time has not been achieved sufficiently.

The present disclosure is made in view of the above-described problem, and an object of the present disclosure is to achieve the shortening of the printing time.

### SUMMARY OF THE DISCLOSURE

An information processing apparatus according to the present disclosure is an information processing apparatus that can communicate with an image forming apparatus, including: at least one memory and at least one processor and/or at least one circuit which function as: a reception unit configured to receive printing setting information used for printing processing of a current printing job that is currently running in the image forming apparatus; an obtainment unit configured to obtain a subsequent printing job registered on a printing queue; and a control unit configured to transmit a subsequent printing job, without a printing processing start command and printing setting information, corresponding to the obtained subsequent printing job, to the image forming apparatus in a case where it is possible to perform continuous printing processing in the image forming apparatus based on printing setting information on the received current printing job and printing setting information on the obtained subsequent printing job.

Further features of the present disclosure will become apparent from the following description of exemplary embodiments with reference to the attached drawings.

### BRIEF DESCRIPTION OF THE DRAWINGS

FIG. 1 is a block diagram of an image forming system including a PC and an image forming apparatus;

FIG. 2 is a conceptual diagram illustrating a configuration of a printer driver included in the PC;

FIG. 3 is a diagram illustrating an example of a printing queue;

FIG. 4 is a diagram illustrating an example of the printing queue;

FIG. 5 is a sequence chart illustrating a flow of conventional continuous feeding processing between pages;

FIG. 6A is a diagram illustrating a configuration example of a printing job of the conventional continuous feeding processing between pages;

FIG. 6B is a diagram illustrating a configuration example of the printing job of the conventional continuous feeding processing between pages;

FIG. 7 is a flowchart illustrating a processing flow of a language monitor;

FIG. 8 is a diagram illustrating an example of a printing job in continuous feeding processing between printing jobs;

FIG. 9 is a flowchart illustrating a flow of the continuous feeding processing between printing jobs by the image forming apparatus;

FIG. 10 is a sequence chart illustrating a flow of the continuous feeding processing between printing jobs;

FIG. 11 is a flowchart illustrating a flow of the continuous feeding processing between printing jobs by the image forming apparatus;

FIG. 12 is a flowchart illustrating a flow of the continuous feeding processing between printing jobs;

FIG. 13A is a diagram illustrating an example of the printing queue;

FIG. 13B is a diagram illustrating an example of the printing queue;

FIG. 14 is a diagram showing the relationship of FIGS. 14A and 14B, and FIGS. 14A and 14B are sequence charts illustrating a flow of the continuous feeding processing between printing jobs;

FIG. 15A is a diagram illustrating an example of the printing queue;

FIG. 15B is a diagram illustrating an example of the printing queue;

FIG. 16 is a flowchart illustrating a processing flow of the language monitor;

FIG. 17 is a flowchart illustrating a flow of processing to control printing processing order of the image forming apparatus;

FIG. 18 is a diagram showing the relationship of FIGS. 18A and 18B, and FIGS. 18A and 18B are sequence charts illustrating a flow of the continuous feeding processing between printing jobs;

FIG. 19 is a schematic diagram illustrating processing to change printing processing waiting order;

FIG. 20 is a diagram illustrating an example of a setting screen displayed on a panel of the image forming apparatus;

FIG. 21 is a flowchart illustrating a processing flow of the language monitor; and

FIG. 22 is a flowchart illustrating a processing flow of the language monitor.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

An information processing apparatus to which the present disclosure is applied and an external apparatus connected to the information processing apparatus are described. In the present embodiment, a personal computer (hereinafter, referred to as a “PC”) is exemplified as the information processing apparatus. Note that, the information processing apparatus is not limited to the PC, and a variety of apparatuses such as an image processing apparatus, a mobile terminal, a smartphone, and a tablet terminal are applicable. Additionally, an image forming apparatus communicable with the information processing apparatus is exemplified as the external apparatus connected to the information processing apparatus to which the present disclosure is applied. The image forming apparatus may be an apparatus such as an ink jet printer, a full-color laser beam printer, a monochrome printer, a copier, and a facsimile apparatus. Moreover, those apparatuses may be multi-function or single-function.

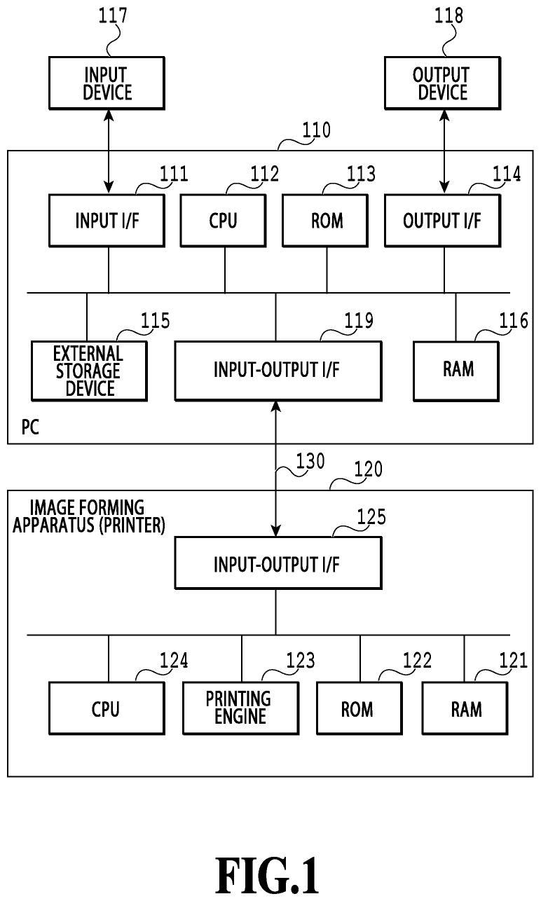

A configuration of an image forming system including the information processing apparatus in the present embodiment and the image forming apparatus in the present embodiment is described with reference to a block diagram in FIG. 1. Additionally, although the present embodiment is described using the following configurations as an example, the present embodiment is applicable in relation to an information processing apparatus communicable with an image forming apparatus, and the configuration of the present embodiment is not limited to the configuration illustrated in FIG. 1.

A PC 110 is the information processing apparatus in the present embodiment. The PC 110 includes an input I/F 111, a CPU 112, a ROM 113, an output I/F 114, an external storage device 115, a RAM 116, an input device 117, an output device 118, and an input-output I/F 119.

The CPU 112 is a system control unit and controls overall the PC 110.

The ROM 113 stores a control program executed by the CPU 112 and fixed data such as a data table.

The external storage device 115 stores an operating system (hereinafter, referred to as an “OS”), a printer driver, other various data, and software. Note that, Windows (registered trademark) is used as the OS as an example in the present embodiment.

The RAM 116 includes a static random access memory (SRAM) or the like that requires a backup power supply and holds data by a not-illustrated primary battery for data backup. Note that, the RAM 116 stores a program control variable and the like related to an operation of the PC 110. Additionally, the RAM 116 is also used as a working memory by various programs saved in the ROM 113 and the external storage device 115.

The input device 117 corresponds to an operation unit that receives an operation from a user and includes a key and the like such as a numeral input key, a mode setting key, a determination key, a cancel key, and a power supply key. Note that, the input device 117 is connected to the input I/F 111. The input I/F 111 is an interface that receives data input and an operation instruction from the user through the input device 117.

The output device 118 corresponds to a display unit that displays data and a status of the PC 110 and includes a light-emitting diode (LED), a liquid crystal display (LCD), and the like. Note that, the output device 118 is connected to the output I/F 114. The output I/F 114 is an interface that performs control for the output device 118 to display data and make a notification of the status of the PC 110. Note that, the input device 117 and the output device 118 may have the same configuration by using the same member to display the information and receive the operation.

The input-output I/F 119 is connected with an input-output I/F 125 through a connection interface 130. The connection between the input-output I/F 119 and the input-output I/F 125 allows intercommunication between the PC 110 and a printer 120. Note that, the input-output I/F 119 corresponds to a port in the present embodiment. The port is a unit that allows communication between devices each including a port by connecting the ports through the connection interface 130. A type of the port may be a network port for establishing a connection through a network or a USB port for establishing a connection using a printer and a USB, for example. Note that, in a connection through a network, the network port may be directly connected by wireless connection or may be connected through an access point disposed on a wired network. The connection through a network is established by a wired LAN or a wireless LAN, for example. Additionally, a communication method of the connection may include wireless fidelity (Wi-Fi) (registered trademark), Bluetooth (registered trademark), near field communication (NFC; ISO/IEC IS 18092), and the like. Note that, the network port may be prepared individually depending on the corresponding communication method and connection method. Note that, in the present embodiment, the PC 110 is connected with the printer 120 by using a port 1. Additionally, the number of the PC 110 is not limited to one, and the plural PCs 110 may be connected with the printer 120.

The connection interface 130 includes a USB, a LAN, and the like, for example; however, it is not limited to these. Note that, communication between the devices may be directly established by wireless communication or may be established through an access point disposed on a wired network. The communication method may include Wi-Fi, Bluetooth, NFC, and the like, for example.

An image forming apparatus 120 (hereinafter, referred to as the “printer 120”) is the external apparatus in the present embodiment. The printer 120 includes a RAM 121, a ROM 122, a printing engine 123, a CPU 124, and the input-output I/F 125.

The CPU 124 is a system control unit and controls overall the printer 120.

The ROM 122 stores a control program executed by the CPU 124 and fixed data such as a data table.

The RAM 121 includes a static random access memory (SRAM) or the like that requires a backup power supply and holds data by a primary battery for data backup (not illustrated). Note that, the RAM 121 stores a program control variable and the like related to an operation of the PC 110. Additionally, the RAM 121 is used as a working memory of the CPU 124 and also used as a buffer for temporal saving of received data.

Based on the data saved in the RAM 121 and a printing job received from the PC 110, the printing engine 123 forms an image on a medium such as paper by using a printing material such as ink and outputs a printed product.

The input-output I/F 125 is connected with the input-output I/F 119 through the connection interface 130.

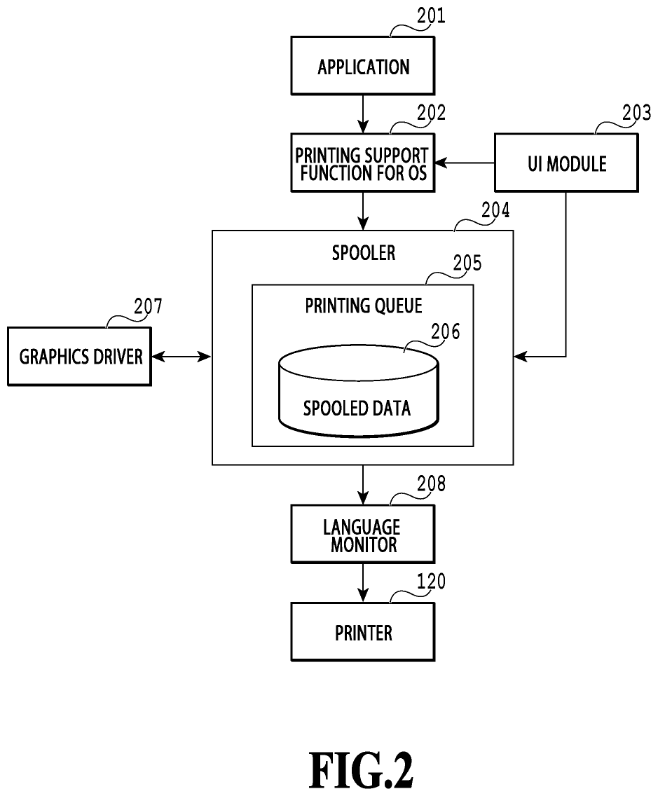

FIG. 2 is a conceptual diagram illustrating a configuration of the printer driver included in the PC 110. With reference to FIG. 2, a configuration of the software stored in the external storage device 115 is described. In the configuration illustrated in FIG. 2, a printing support function 202 for the OS, a spooler 204, a printing queue 205 (a printing queue), and spooled data 206 are modules of the OS. A UI module 203, a graphics driver 207, and a language monitor 208 are modules of the printer driver. Each configuration may be a module of either one of the OS and the printer driver. Processing executed by each configuration is implemented by the CPU 112 reading a program corresponding to each configuration from the external storage device 115, loading the program into the RAM 116 and executing the program. An application 201 is saved in the external storage device 115 and creates image data information, which includes image information and character information on paid contents and the like to be printed, and printing data, which includes printing setting information and the like including medium, sheet size, layout, and the like.

The printing setting information returned from the UI module 203 through the printing support function 202 for the OS is added to the printing data created by the application 201, and the printing data is temporarily saved in the printing queue 205 of the spooler 204 as the spooled data 206. The spooler 204 has a job management function and holds and manages the provided spooled data 206 until it is recognized that the transmission of the printing job according to the spooled data 206 is completed. Specifically, for example, the spooler 204 manages a size, a job name, and the like of the printing job of each printer and transfers the managing information to a status display application to display the information on the output device 118 and the like. Note that, for example, information on the spooled data 206 saved in the printing queue 205 can be referred by using a predetermined interface function through the graphics driver 207, the UI module 203, the application 201, and the like.

The spooled data 206 is converted by the graphics driver 207 into a printing command that the printer 120 is able to construe, and the printing job is generated. The generated printing job is transmitted from the spooler 204 to the language monitor 208. The language monitor 208 divides the printing job into a packet of a specific size and transmits the printing job point by point to the printer 120 through the input-output I/F 119 and the input-output I/F 125. Note that, in this process, the data size to be transmitted each time is instructed by the spooler 204. Note that, the spooler 204 executes the instruction by being instructed by the application 201 and the UI module 203. Additionally, as a function of the language monitor 208, there is a function to obtain information on a status of the printer 120 or a job inputted to the printer 120. Note that, the job is the printing job, a scanning job, a maintenance job, and the like, for example. The PC 110 executes processing such as printing, scanning, and maintenance depending on the job by transmitting the job to the printer 120.

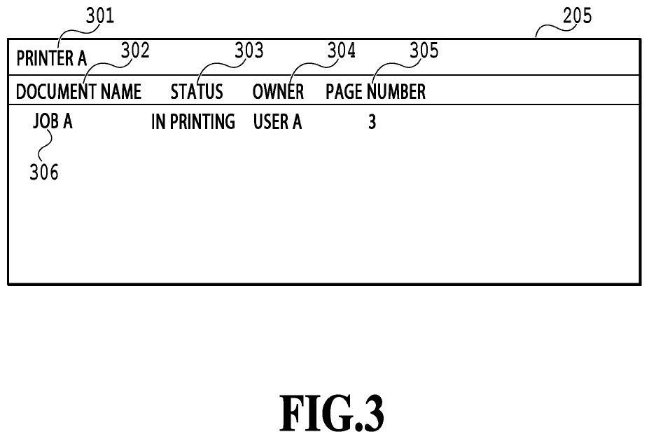

FIG. 3 is an example of the printing queue 205 in Windows (registered trademark) of Microsoft Corporation. The printing queue 205 is a graphical user interface that holds and manages the spooled data 206 provided from the spooler 204 until it is recognized that the transmission of the printing job according to the spooled data 206 is completed. The printing queue displays information on a processing state of the spooled data 206 and the printing job generated by the graphics driver 207 based on the spooled data 206.

A printer name display region 301 displays a printer name. A document name display region 302 displays names of the spooled data 206 and the printing job generated by the graphics driver 207 from the spooled data 206.

A status display region 303 displays a status of the spooled data 206 and the printing job generated by the graphics driver 207 based on the spooled data 206. For example, in a case where in printing displayed, it indicates that printing processing is executed by the printer 120. In a case where nothing is displayed, it indicates that the spooled data 206 is on standby without being subjected to processing such as generation processing and transmission processing of the printing job. Hereinafter, the spooled data on standby without being subjected to processing such as generation processing and transmission processing of the printing job is called a “standby printing job”.

An owner display region 304 displays an owner of the spooled data 206 and the printing job generated by the graphics driver 207 based on the spooled data 206. In other words, a name of the user who executes the printing processing is displayed.

A page number display region 305 displays the number of pages of the spooled data 206 and the printing job generated by the graphics driver 207 based on the spooled data 206.

A job display region 306 displays the spooled data 206 saved in the spooler 204. The printing queue 205 holds and manages the spooled data 206 until it is recognized that the transmission of the printing job according to the spooled data 206 is completed. The example in FIG. 3 illustrates that a job A with a page number of three pages owned by a user A is in printing.

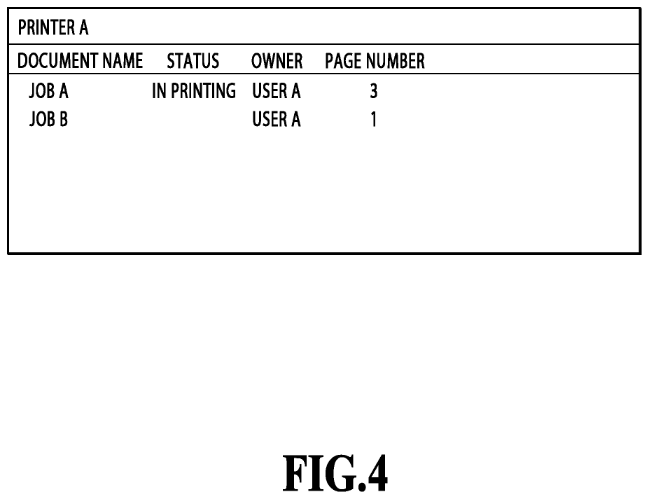

In addition to the example in FIG. 3, FIG. 4 illustrates that there is a printing job in which a job B with a page number of one page owned by the user A is on standby. In a case where the language monitor 208 finishes the transmission of the printing job of the job A to the printer 120, the job A is deleted from the printing queue 205, and processing of printing job generation of the job B by the graphics driver 207 is started. Thus, the spooler 204 does not process the jobs registered on the printing queue 205 in parallel but sequentially processes the jobs one by one.

First, general continuous feeding processing between pages as a comparative example that is regardless of the processing of the present embodiment is described.

The continuous feeding processing is processing for a case of printing plural pages as a method of shortening the printing time. In the continuous feeding processing, feeding of a sheet of the next page is started during the printing processing in a case where it is determined that the same printing setting is applied to the printing of the next page. This allows a shortening of the printing time between pages more than processing in which feeding is performed after the printing of the current printing processing ends. A method of executing this continuous feeding processing between pages in a case where plural pages are processed with a single printing job is described.

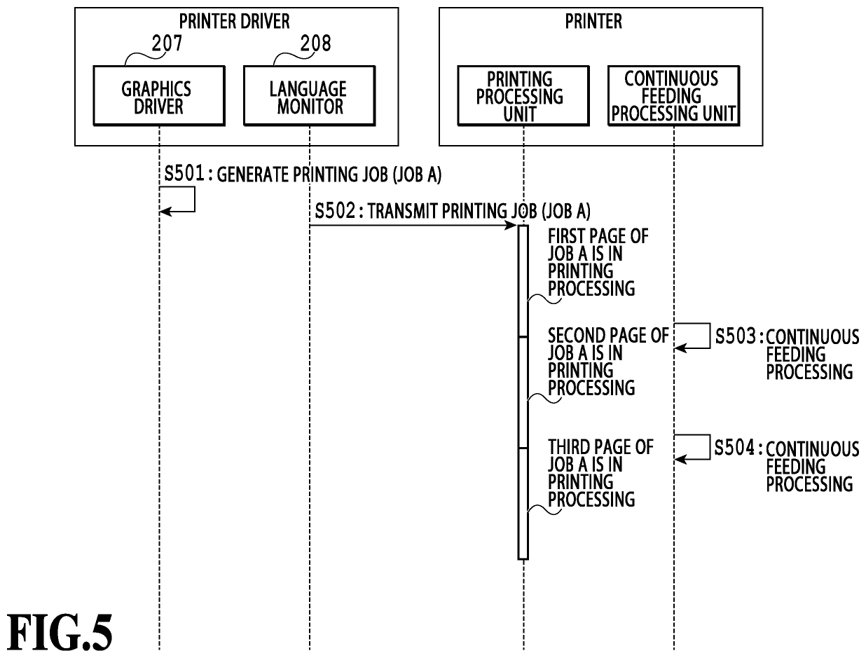

FIG. 5 illustrates the continuous feeding processing flow between the plural pages in the example in FIG. 3.

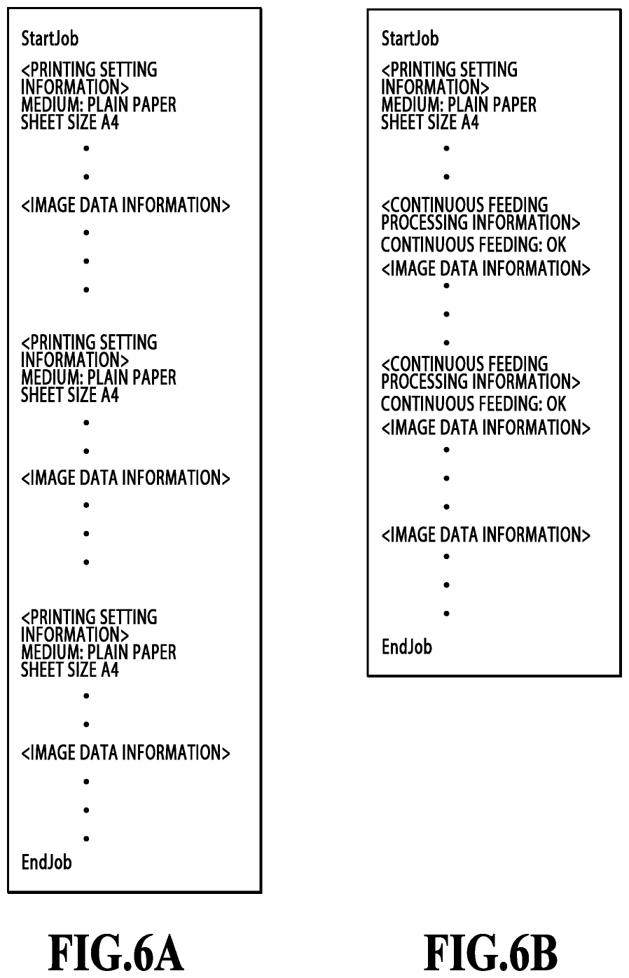

In S501, in a case where the job A is registered on the printing queue 205, the graphics driver 207 of the printer driver generates the printing job. Configuration examples of the generated printing job are illustrated in FIGS. 6A and 6B.

First, a configuration example of a usually-generated printing job in a case where the graphics driver 207 does not perform the continuous feeding processing, which is illustrated in FIG. 6A, is described. A StartJob command, which is a printing processing start command, is stored into the RAM 121. Next, the printing setting information is formed. For example, as the printing setting information, the printing setting that is set by the graphical user interface and displayed on the UI module 203 is stored into the RAM 121. In this case, the printing setting indicating “medium: plain paper, sheet size: A4” is stored into the RAM 121. Additionally, the printing setting other than the medium and the sheet size may be stored into the RAM 121. Next, the image data information is formed. Specifically, data generated in an image format corresponding to the printer 120 is stored into the RAM 121. These are information and data of the first page. The printing setting information and the image data information on the second page and the third page are stored into the RAM 121, and finally, the graphics driver 207 stores an EndJob command, which is a printing processing end command indicating the end of the printing job, into the RAM 121.

A configuration example of the printing job that allows the graphics driver 207 to perform the continuous feeding processing between pages, which is illustrated in FIG. 6B, is described. First, as with the case of FIG. 6A, the StartJob command and the printing setting information on the first page are stored into the RAM 121. Next, continuous feeding processing information is stored into the RAM 121. Specifically, the graphics driver 207 compares the printing setting information between the current page and the next page and determines whether the continuous feeding is possible.

In a case where the graphics driver 207 determines that the continuous feeding is possible, the graphics driver 207 stores a command of “continuous feeding: OK” of the continuous feeding processing information into the RAM 121.

In a case where the graphics driver 207 determines that the continuous feeding is impossible, the graphics driver 207 does not store the continuous feeding processing information into the RAM 121.

In the example in FIG. 6B, the graphics driver 207 compares the printing setting information between the first page and the second page and determines whether the continuous feeding is possible. In the example in FIG. 6B, a condition that continuous feeding is possible is that the medium and the sheet size match. In this example, the medium and the sheet size in the printing setting information of the first page are the same as those of the second page. Therefore, the graphics driver 207 determines that the continuous feeding is possible, and the graphics driver 207 stores the command of “continuous feeding: OK” of the continuous feeding processing information into the RAM 121. Then, the graphics driver 207 stores the image data of the first page into the RAM 121. These are the information and the data of the first page.

For the second page, in a case where the command of “continuous feeding: OK” of the continuous feeding processing information is stored in the process of the first page, the graphics driver 207 does not store the printing setting information. Then, the graphics driver 207 compares the printing setting information between the second page and the third page. In a case where it is determined that the continuous feeding is possible, the graphics driver 207 stores the command of “continuous feeding: OK” of the continuous feeding processing information into the RAM 121. The graphics driver 207 stores the image data information on the second page into the RAM 121.

For the third page, since the command of “continuous feeding: OK” of the continuous feeding processing information is stored into the RAM 121 in the process of the second page, the graphics driver 207 stores the image data of the third page into the RAM 121 without storing the printing setting information. Finally, the graphics driver 207 stores the EndJob command into the RAM 121.

Referring back to FIG. 5, details of the continuous feeding processing flow between plural pages are described below.

In S501, the graphics driver 207 generates the printing job illustrated in FIG. 6B. In a case of generating the printing job, the graphics driver 207 transmits the generated printing job from the spooler 204 to the language monitor 208. Note that, in actuality, the generated printing job may be sequentially transmitted to the language monitor 208 while generating the next printing job. In a case where the language monitor 208 receives the printing job from the spooler 204, the processing proceeds to S502.

In S502, the language monitor 208 transmits the printing job to the printer 120. The printer 120 receives the printing job and starts the printing processing. In a case where the printer 120 starts the printing processing, the processing proceeds to S503.

In S503, the printer 120 recognizes that there is the command indicating that the continuous feeding processing is possible between the first page and the second page of the printing job. Therefore, the printer 120 starts feeding of a sheet of the second page during the printing processing of the first page by a continuous feeding processing unit of the printer 120. Thus, it is possible to immediately process ending the printing of the first page and starting the printing of the second page, and the printing time is shortened. In a case where the printing of the second page is started, the processing proceeds to S504.

In S504, the printer 120 recognizes that there is the command indicating that the continuous feeding processing is possible between the second page and the third page of the printing job. Therefore, the printer 120 starts feeding of a sheet of the third page during the printing processing of the second page.

The continuous feeding processing between plural pages in a single printing job is described above. In this example, the continuous feeding processing between pages in a single printing job is possible. However, for example, in a case where the printing processing of the job B is subsequently started after the printing processing of the job A ends as illustrated in FIG. 4, the continuous feeding processing between the job A and the job B is not executed. Details of the continuous feeding processing between plural printing jobs are described below.

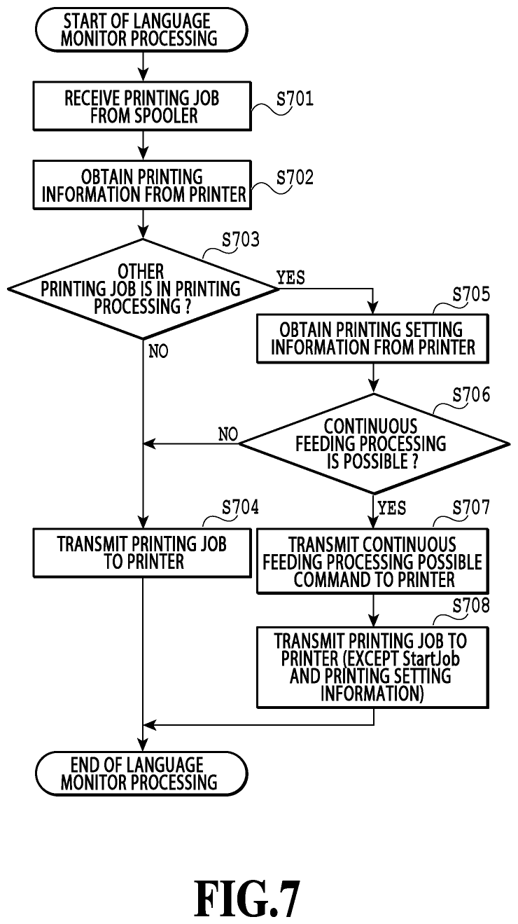

FIG. 7 is a flowchart illustrating a processing flow of the language monitor 208 of the present embodiment. Various commands, information, and data are transmitted and received between the language monitor 208 and the printer 120.

In S701, the language monitor 208 receives the printing job generated by the graphics driver 207 from the spooler 204. In a case where the language monitor 208 receives the printing job, the processing proceeds to S702.

In S702, the language monitor 208 obtains the printing information from the printer 120 without transmitting the printing job to the printer 120. In a case where the language monitor 208 obtains the printing information, the processing proceeds to S703.

In S703, the language monitor 208 determines whether the printer 120 is in the printing processing of another printing job based on the obtained printing information. In a case where the other printing job is in the printing processing and the received printing job is not in the printing processing, the language monitor 208 determines that the other printing job is in the printing processing, and the processing proceeds to S705. In a case where the language monitor 208 determines that there is no printing job in the printing processing or the received printing job is in the printing processing based on the obtained printing information, the language monitor 208 determines that the other printing job is not in the printing processing, and the processing proceeds to S704.

In S704, the language monitor 208 transmits the printing job received in S701 to the printer 120. In a case where the language monitor 208 transmits the printing job to the printer 120, the processing flow illustrated in FIG. 7 is finished.

In S705, the language monitor 208 obtains the printing setting information from the printer 120, and the processing proceeds to S706.

In S706, based on the obtained printing setting information, the language monitor 208 determines whether the continuous feeding processing is possible. The determination on whether the continuous feeding processing is possible may be determined based on whether the medium and the sheet size of the obtained printing setting information match those of the printing setting information on the printing job in the current printing processing, or may be determined by comparing the obtained printing setting information with the printing setting information on the other printing job. In a case where the printing setting information on the printing jobs match, the language monitor 208 determines that it is possible to perform the continuous feeding processing, and the processing proceeds to S707. In a case where the printing setting information on the printing jobs do not match, the language monitor 208 determines that it is impossible to perform the continuous feeding processing, and the processing proceeds to S704. In a case where the language monitor 208 transmits the printing job to the printer 120, the processing flow illustrated in FIG. 7 is finished.

In S707, the language monitor 208 transmits a continuous feeding processing possible command to the printer 120, and the processing proceeds to S708.

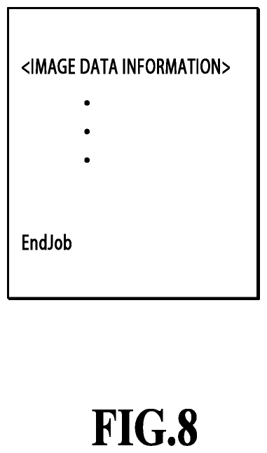

In S708, the language monitor 208 transmits the printing job from which the StartJob command and the printing setting information are deleted to the printer 120. FIG. 8 is an example of the printing job from which the StartJob command and the printing setting information are deleted that is transmitted to the printer 120 in S708. The StartJob command and the printing setting information are deleted from the printing job, and only the image data and the EndJob command are transmitted to the printer 120. In a case where there is data other than the image data and the EndJob command except for the StartJob command and the printing setting information, the language monitor 208 transmits also the data to the printer 120, and the processing flow illustrated in FIG. 7 is finished.

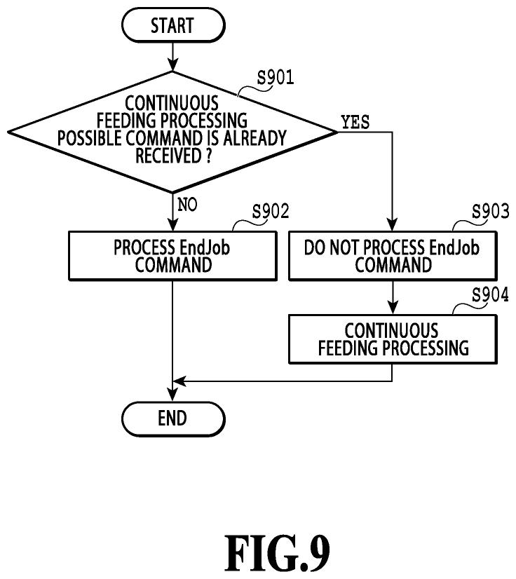

FIG. 9 is a flowchart illustrating a flow related to the determination on whether to process the EndJob command and the continuous feeding processing between printing jobs by the printer 120. Various commands, information, and data are transmitted and received between the printer 120 and the language monitor 208. In a case of a normal printing job, the printer 120 processes the EndJob command.

In S901, the printer 120 confirms whether the continuous feeding processing possible command is already received before processing the EndJob command. In a case where the printer 120 already receives the continuous feeding processing possible command, the processing proceeds to S903. In a case where the printer 120 does not receive the continuous feeding processing possible command, the processing proceeds to S902.

In S902, the printer 120 processes the EndJob command, and the processing flow illustrated in FIG. 9 is finished.

In S903, since the next printing job is the printing job of the continuous feeding processing, the StartJob command is not transmitted to the printer 120. Accordingly, the printer 120 does not process the EndJob command in the printing processing. Specifically, since the printer 120 does not process the EndJob command in the printing processing, the printer 120 does not perform the job end processing and the processing proceeds to S904.

In S904, the printer 120 executes the continuous feeding processing between printing jobs. Specifically, the printer 120 continuously perform the printing processing such as feeding of the next printing job. However, the printing job in the current printing processing and the printing job of the continuous feeding processing are not treated as a single printing job. The printer 120 counts the number of the printing processing and the page number of each printing job. In a case where the printer 120 performs the continuous feeding processing between printing jobs, the processing flow illustrated in FIG. 9 is finished.

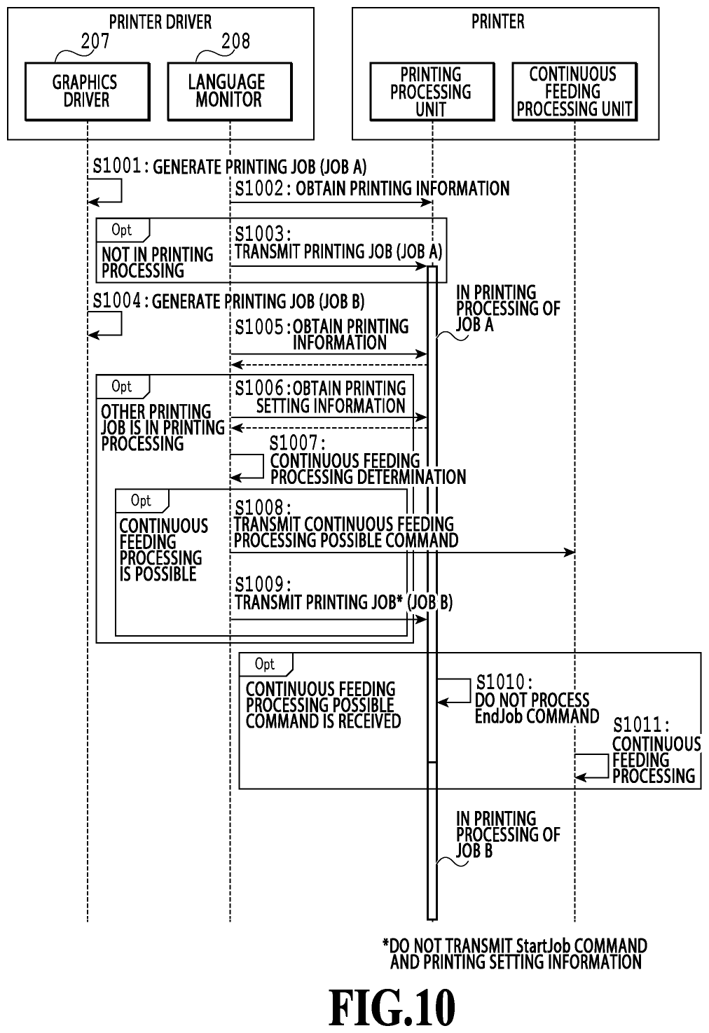

FIG. 10 is a sequence chart illustrating a flow of the continuous feeding processing between plural printing jobs in which the printing queue in FIG. 4 is processed by using the processing flow of the present embodiment described in FIGS. 7 and 9.

In S1001, in a case where the job A is registered on the printing queue 205, the graphics driver 207 of the printer driver generates the printing job of the job A. The printing job generated by the graphics driver 207 is the same as the printing job illustrated in FIG. 6B. In a case where the graphics driver 207 generates the printing job, the processing proceeds to S1002.

In S1002, the language monitor 208 obtains the printing information from the printer 120 before transmitting the generated printing job of the job A to the printer 120. In a case of being requested the obtainment of the printing information from the language monitor 208, the printer 120 returns whether the other printing job is in the printing processing to the language monitor 208, and the processing proceeds to S1003. In the present embodiment, since the printer 120 is not in the printing processing of the other printing job, the printer 120 returns “not in printing processing” to the language monitor 208.

In S1003, in a case where the language monitor 208 determines that the printer 120 is not in the printing processing of the other printing job based on the obtained printing information, the language monitor 208 transmits the generated printing job of the job A to the printer 120, and the processing proceeds to S1004. In a case where the language monitor 208 determines that it is in the printing processing, the language monitor 208 executes the processing subsequent to S1006 described later. Here, description of the processing is omitted. In a case where the printer 120 receives the printing job of the job A, the printer 120 starts the processing of the printing job of the job A. In this process, the continuous feeding processing between pages is performed. However, since the continuous feeding processing between pages is the same processing as that in FIG. 5, description is omitted.

In S1004, in a case where the language monitor 208 ends the transmission of the printing job of the job A to the printer 120, the job A is deleted from the printing queue 205, and processing of the job B is started. That is, the graphics driver 207 generates a printing job of the job B, and the processing proceeds to S1005.

In S1005, after the graphics driver 207 generates the printing job of the job B, the language monitor 208 obtains the printing information from the printer 120 before transmitting the generated printing job of the job B to the printer 120. In a case of being requested the obtainment of the printing information from the language monitor 208, the printer 120 returns whether the other printing job is in the printing processing to the language monitor 208. In the present embodiment, since the printer 120 is in the printing processing of the job A, the printer 120 returns “in printing processing” to the language monitor 208.

In a case where the language monitor 208 obtains the information indicating that the printer 120 is in the printing processing, the language monitor 208 determines that the other printing job is in the printing processing because the printing job of the job B is not in the printing processing, and the processing proceeds to S1006. In this process, in a case where it is determined that the printer 120 is not in the printing processing of the other printing job, the processing similar to S1003 is executed. However, description thereof is omitted here.

In S1006, if the language monitor 208 determines that the printer 120 is in the printing processing of the other printing job, the language monitor 208 obtains the printing setting information from the printer 120. In a case of being requested the obtainment of the printing setting information from the language monitor 208, printer 120 returns the printing setting information in the printing processing to the language monitor 208, and the processing proceeds to S1007. In a case of the present embodiment, “medium: plain paper, sheet size: A4” that is the printing setting information on the job A in the printing processing is returned to the language monitor 208.

In S1007, in a case where the language monitor 208 obtains the printing setting information from the printer 120, the language monitor 208 determines whether the continuous feeding processing between the last page of the job A and the first page of the job B is possible. The language monitor 208 compares the printing setting information on the job B obtained from the printer 120 with the printing setting information on the job A obtained from the printer 120. In a case of the present embodiment, since the medium and the sheet size of the printing jobs both match, the language monitor 208 determines that the continuous feeding processing between printing jobs is possible, and the processing proceeds to S1008.

In S1008, the language monitor 208 determines that the continuous feeding processing between printing jobs is possible and transmits the continuous feeding processing possible command to the printer 120, and the processing proceeds to S1009.

In S1009, the language monitor 208 transmits the printing job of the job B to the printer 120. In this process, as illustrated in FIG. 8, the language monitor 208 transmits the printing job from which the StartJob command and the printing setting information are deleted to the printer 120, and the processing proceeds to S1010.

In S1010, since the printer 120 performs the continuous feeding processing between printing jobs in a case where the printer 120 receives the continuous feeding processing possible command, the printer 120 does not process the EndJob command of the printing job of the job A. Specifically, the printer 120 does not perform the job end processing of the printing job of the job A, and the processing proceeds to S1011.

In S1011, the printer 120 executes the continuous feeding processing between printing jobs. Specifically, the printer 120 continuously performs the printing processing such as feeding while treating the next printing job as the single printing job. However, the number of the printing processing and the page number of the printing job are not counted as that of the single printing job but different printing jobs. Additionally, in a case where the printer 120 receives the continuous feeding processing possible command, the printer 120 performs the continuous feeding processing in which feeding of the printing job of the job B is started during the printing processing of the printing job of the job A. Thus, after the printing processing of the printing job of the job A is finished, the printing processing of the printing job of the job B is started immediately.

A method of implementing the continuous feeding processing between multiple printing jobs is as described above. This allows the printer 120 to execute the continuous feeding processing between multiple printing jobs, and it is possible to shorten the printing time between the multiple printing jobs.

In the present embodiment, in order to determine whether the printer 120 is able to perform the continuous feeding processing between printing jobs, the language monitor 208 inquires the printer 120 about the printing setting information in the printing processing. As a sixth embodiment described later, the language monitor 208 may perform the following processing so as to make it possible to implement the continuous feeding processing between printing jobs even in a case where a capacity of a buffer holding the printing jobs in the printer 120 is small. That is, the language monitor 208 may determine whether the continuous feeding processing between printing jobs is possible by obtaining the printing setting information in the printing processing from the printing queue 205.

Additionally, in a case where it is determined that it is too late to perform the continuous feeding processing between printing jobs even if the printer 120 receives the continuous feeding processing possible command, the printer 120 may perform normal printing processing without performing the continuous feeding processing between printing jobs.

### Second Embodiment

In the first embodiment, the processing in which the printer driver determines whether the continuous feeding processing between printing jobs is possible, is described. In a second embodiment, a processing flow in which the printer 120 determines whether it is possible to perform the continuous feeding processing between printing jobs, is described.

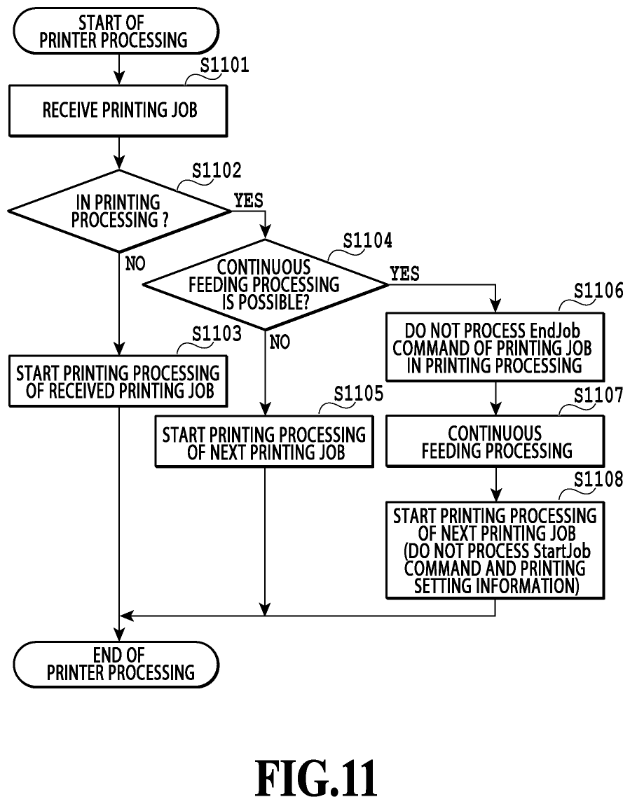

FIG. 11 is a flowchart illustrating the processing flow of the printer 120 in the second embodiment.

In S1101, the printer 120 receives the printing job from the language monitor 208, and the processing proceeds to S1102.

In S1102, the printer 120 determines whether the other printing job is in the printing processing. If the printer 120 is in the printing processing of the other printing job, the processing proceeds to S1104. If the printer 120 is not in the printing processing of the other printing job, the processing proceeds to S1103.

In S1103, the printer 120 starts the printing processing of the received printing job, and the processing of the flowchart illustrated in FIG. 11 is finished.

In S1104, the printer 120 compares the printing setting information between the printing job in the printing processing and the received next printing job and determines whether it is possible to perform the continuous feeding processing between printing jobs. The method of determining whether the printer 120 is able to perform the continuous feeding processing between printing jobs may be, for example, determination on whether the medium and the sheet size match or determination based on other printing setting. In a case where it is determined that the printer 120 is unable to perform the continuous feeding processing between printing jobs, the processing proceeds to S1105. In a case where it is determined that the printer 120 is able to perform the continuous feeding processing between printing jobs, the processing proceeds to S1106.

In S1105, after the printing in the printing processing ends, the printer 120 starts the printing processing of the next printing job, and the processing flow illustrated in FIG. 11 is finished.

In S1106, the printer 120 does not process the EndJob command of the printing job in the printing processing, and the processing proceeds to S1107.

In S1107, the printer 120 performs the continuous feeding processing between printing jobs, and the processing proceeds to S1108.

In S1108, after the printing in the printing processing ends, the printer 120 starts the printing processing of the next printing job. In this process, the printer 120 performs the printing processing of the next printing job without processing the StartJob command and the printing setting information, and the processing flow illustrated in FIG. 11 is finished.

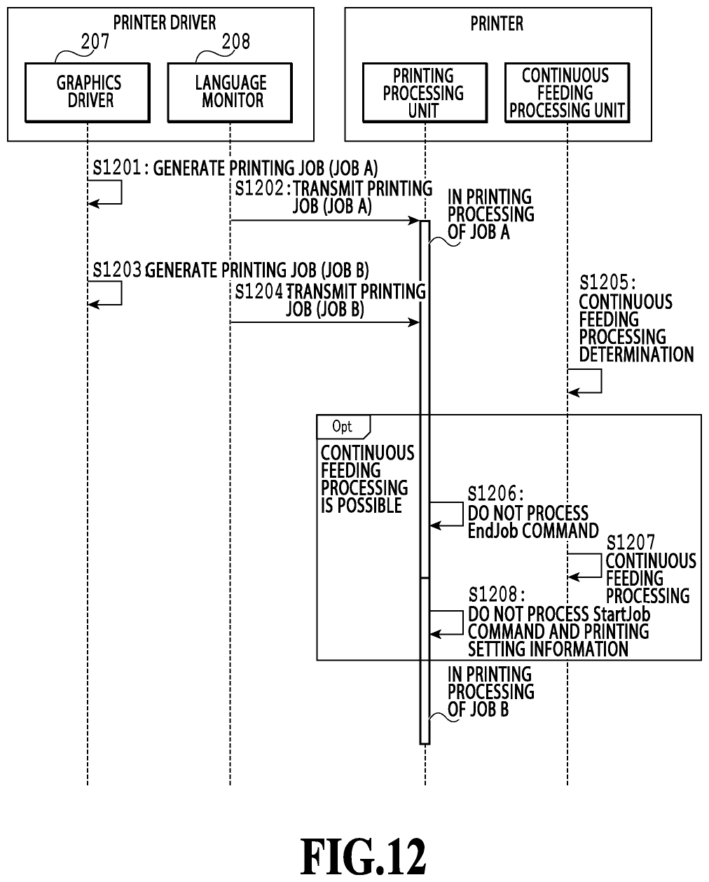

FIG. 12 is a sequence chart illustrating a flow of the continuous feeding processing between plural printing jobs in which the printing queue in FIG. 4 is processed by using the processing flow of the printer 120 of the second embodiment described in FIG. 11.

In S1201, the graphics driver 207 of the printer driver generates the printing job of the job A, and the processing proceeds to S1202.

In S1202, the language monitor 208 transmits the printing job of the job A to the printer 120. In a case of receiving the printing job of the job A from the language monitor 208, the printer 120 starts the printing processing of the job A, and the processing proceeds to S1203.

In S1203, the graphics driver 207 generates the printing job of the job B, and the processing proceeds to S1204.

In S1204, the language monitor 208 transmits the printing job of the job B to the printer 120. In a case where the printing job of the job B is transmitted, the language monitor 208 transmits the printing job of the job B to the printer 120 without deleting the StartJob command and the printing setting information as illustrated in FIG. 6A, and the processing proceeds to S1205.

In S1205, in a case where the printer 120 receives the printing job of the job B during the printing processing of the printing job of the job A, the printer 120 compares the printing setting information on the printing job of the job B with the printing setting information on the received printing job of the job A. Based on the comparison result of the printing setting information, the printer 120 determines whether the continuous feeding processing between printing jobs is possible. In a case of the second embodiment, since both the medium and the sheet size match between the printing job of the job A and the printing job of the job B, the printer 120 determines that the continuous feeding processing between printing jobs is possible, and the processing proceeds to S1206.

In S1206, the printer 120 does not process the EndJob command of the printing job of the job A, and the processing proceeds to S1207.

In S1207, the printer 120 performs the continuous feeding processing between printing jobs, and the processing proceeds to S1208.

In S1208, the printer 120 starts the processing of the printing job of the job B. In this process, the printer 120 performs the printing processing of the printing job of the job B without processing the StartJob command and the printing setting information of the printing job of the job B. Specifically, in the second embodiment, the printer 120 reads and discards the StartJob command and the printing setting information to start from the processing of the image data, which is the next information of the printing setting information, and performs the printing processing of the printing job of the job B.

In the second embodiment, the printer driver does not determine whether it is possible to execute the continuous feeding processing between printing jobs. The printer 120 determines whether it is possible to execute the continuous feeding processing between printing jobs. Thus, it is possible to shorten the printing time between the plural printing jobs.

Comparing with a case of determining whether it is possible to execute the continuous feeding processing between printing jobs by the printer driver, there is a demerit that the printer 120 needs a buffer to receive and hold enough printing jobs to be able to make the determination. However, as described in an embodiment described later, in a case where the printer 120 can receive and hold plural printing jobs, the printer 120 has a merit described as follows. That is, in a case where the printer 120 performs the continuous feeding processing between printing jobs after receiving the printing jobs from plural users, the printer 120 can change the order of processing the printing jobs.

### Third Embodiment

In the first embodiment, a method of performing the continuous feeding processing between printing jobs in a case where the multiple printing jobs are registered on the printing queue 205 of one user is described. In a third embodiment, a method of performing the continuous feeding processing between printing jobs in a case where the printing jobs are processed in the printing queues 205 of users of plural PCs.

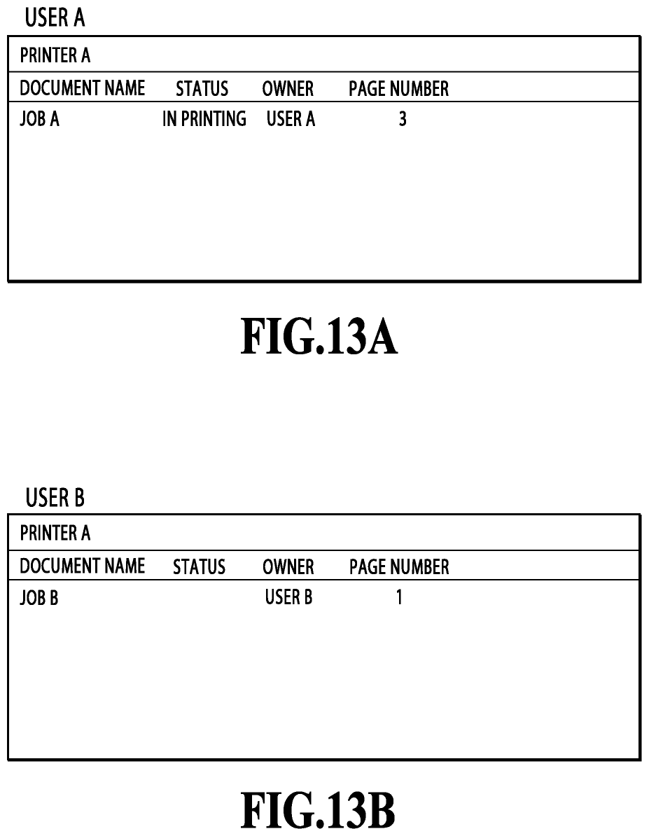

FIGS. 13A and 13B are an example illustrating the printing queues 205 of the users of the plural PCs.

FIG. 13A illustrates that the printing job of the job A of the user A of a PC 110A is transmitted to the printer 120, and the printing job is in the printing processing by the printer 120.

FIG. 13B illustrates that the printing job of the job B of a user B is transmitted from a PC 110B, which is a PC different from that of the user A, to the printer 120, and the printing job is in a state of being registered on the printer 120. In other words, it is an example in which the printing job of the job B is generated in the PC 110B, which is the other PC, while the printer 120 is in the printing processing of the job A of the user A, and the generated printing job of the job B is transmitted to the printer 120.

In the third embodiment, the PC 110B, which is the PC different from the PC 110A in the printing processing, determines whether it is possible to execute the continuous feeding processing between printing jobs on the printing job transmitted from a language monitor 208B. In a case where the PC 110B determines that it is able to execute the continuous feeding processing between printing jobs, the printer 120 performs the continuous feeding processing between printing jobs.

The processing flow of the language monitor 208 of the third embodiment is the same as the processing flow in FIG. 7. The processing flows related to the determination whether the EndJob command is processed and the continuous feeding processing between printing jobs which is performed by the printer 120 are the same as the processing flows in FIG. 9. Thus, descriptions of the above processing flows are omitted.

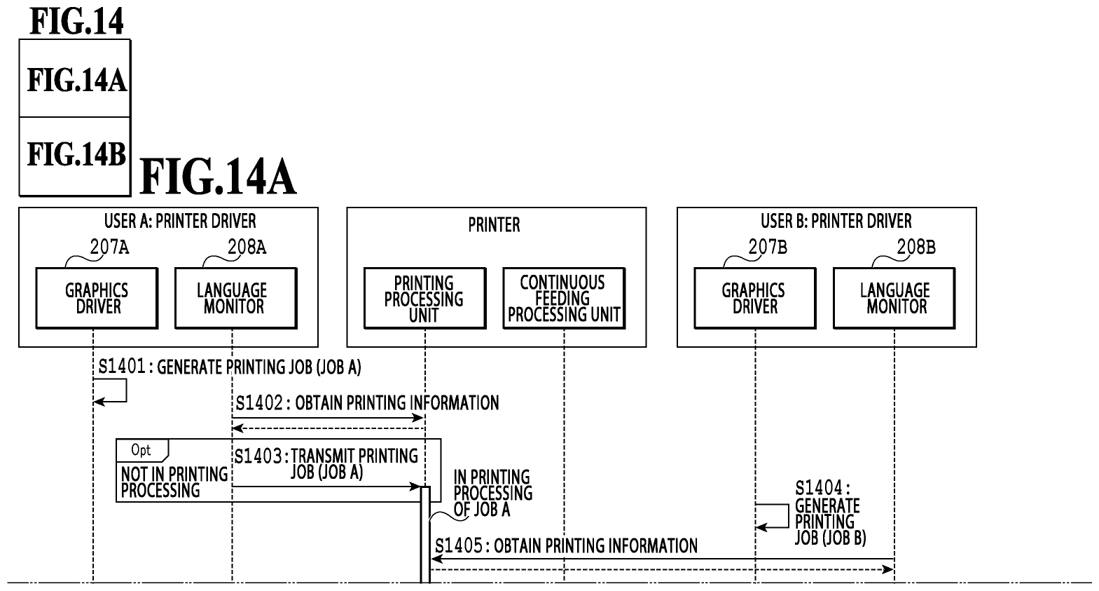

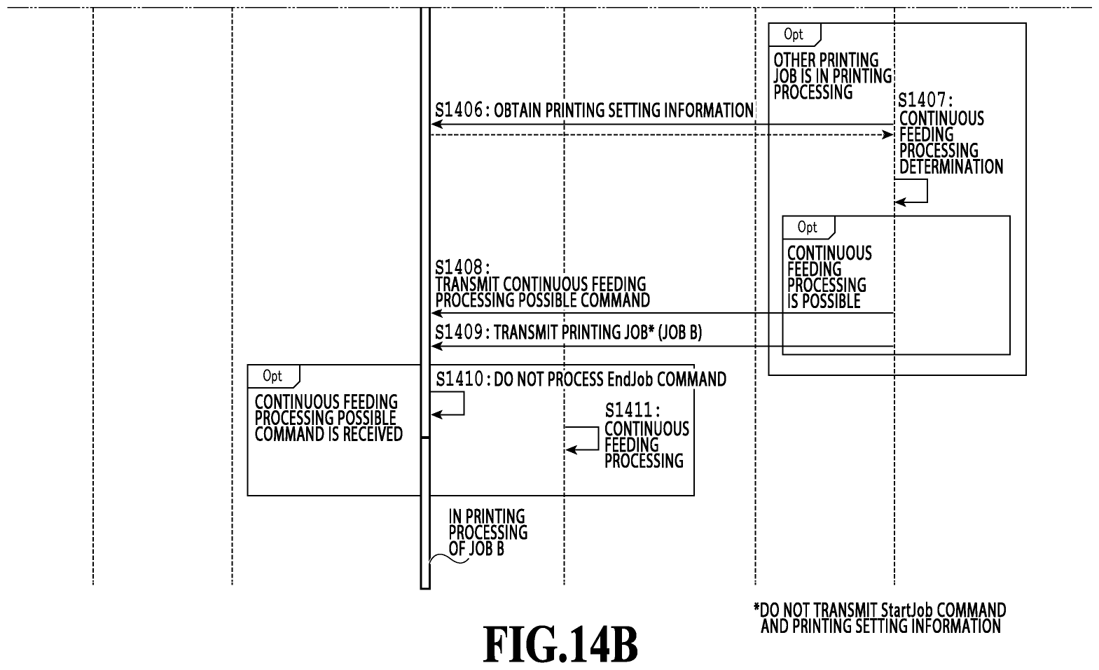

FIGS. 14A and 14B are sequence charts illustrating a processing flow to perform the continuous feeding processing between printing jobs in which the printing queues are processed in FIGS. 13A and 13B by using the processing flows described in FIGS. 7 and 9.

In S1401, in a case where the job A is registered on the printing queue of the PC 110A of the user A, a graphics driver 207A of the printer driver generates the printing job of the job A, and the processing proceeds to S1402. The printing job generated by the graphics driver 207A is the same as the printing job illustrated in FIG. 6B.

In S1402, a language monitor 208A obtains the printing information from the printer 120 before transmitting the generated printing job of the job A. In a case where the printer receives the request of the printing information from the language monitor 208A, the printer 120 returns the printing information indicating whether it is in the printing processing to the language monitor 208A. In the third embodiment, since the printer 120 is not in the printing processing, the printer 120 returns “not in printing processing” to the language monitor 208A, and the processing proceeds to S1403.

In S1403, the language monitor 208A determines that the printer 120 is not in the printing processing based on the obtained printing information and transmits the generated printing job of the job A to the printer 120. In a case of receiving the printing job from the language monitor 208A, the printer 120 starts the printing processing of the job A, and the processing proceeds to S1404. In this process, the continuous feeding processing between pages is performed. Since the processing is the same as the processing in FIG. 5, description of the continuous feeding processing between pages is omitted.

In S1404, while the printer 120 is in the printing processing of the printing job of the job A, the job B is registered on a printing queue 205B of the user B in the PC 110B. In a case where the job B is registered on the printing queue 205B, the graphics driver 207B generates the printing job of the job B, and the processing proceeds to S1405.

In S1405, in a case where the printing job of the job B is generated, the language monitor 208B obtains the printing information from the printer 120 before transmitting the generated printing job of the job B to the printer 120. In a case where the printer 129 receives the request of the printing information from the language monitor 208B, the printer 120 returns the printing information indicating whether it is in the printing processing to the language monitor 208B. Since the printer 120 is in the printing processing of the printing job of the job A, the printer 120 returns “in printing processing” to the language monitor 208B, and the processing proceeds to S1406.

In S1406, the language monitor 208B determines that the printer 120 is in the printing processing of the printing job of the job A and is not in the printing processing of the printing job of the job B and obtains the printing setting information from the printer 120. Then, the processing proceeds to S1407.

In S1407, the language monitor 208B compares the obtained printing setting information and the printing setting information on the printing job of the job B and determines whether the printer 120 is able to execute the continuous feeding processing between printing jobs. In the third embodiment, since both the medium and the sheet size match between the printing job of the job A and the printing job of the job B, the language monitor 208B determines that the printer 120 is able to execute the continuous feeding processing between printing jobs, and the processing proceeds to S1408.

In S1408, in a case where the language monitor 208B determines that the printer 120 is able to execute the continuous feeding processing between printing jobs, the language monitor 208B transmits the continuous feeding processing possible command to the printer 120, and the processing proceeds to S1409.

In S1409, the language monitor 208B transmits the printing job of the job B to the printer 120. In this process, the language monitor 208B transmits the printing job from which the StartJob command and the printing setting information are deleted to the printer 120, and the processing proceeds to S1410.

In S1410, in a case where the printer 120 receives the continuous feeding processing possible command from the language monitor 208B during the printing processing of the printing job of the job A, the printer 120 does not process the EndJob command of the printing job of the job A. This is because the printer 120 executes the continuous feeding processing between printing jobs. Specifically, since the printer 120 does not process the EndJob command of the printing job of the job A, the printer 120 does not perform the job end processing and the processing proceeds to S1411.

In S1411, the printer 120 executes the continuous feeding processing between printing jobs. Specifically, the printer 120 continuously performs the printing processing such as feeding while treating the next printing job as the single printing job. However, the number of the printing processing and the page number of the printing job are not counted as that of the single printing job but different printing jobs. Additionally, in a case where the printer 120 receives the continuous feeding processing possible command, the printer 120 performs the continuous feeding processing in which feeding of the printing job of the job B is started during the printing processing of the printing job of the job A. Thus, after the printing processing of the printing job of the job A ends, the printing processing of the printing job of the job B is started immediately.

As described above, in a case where the printing jobs are processed by the printing queues 205 of the users of the plural PCs, the printer 120 is able to execute the continuous feeding processing between printing jobs, and it is possible to shorten the printing time.

Additionally, in a case where it is determined that it is too late for the continuous feeding processing even if the printer 120 receives the continuous feeding processing possible command, the printer 120 may perform normal printing without performing the continuous feeding processing.

### Fourth Embodiment

In the third embodiment, an example in which the printing job of the job B of the user B is registered while the printer 120 is in the printing processing of the printing job of the job A of the user A is described. However, there may occur a case where a job C is additionally registered on a printing queue 205A of the user A.

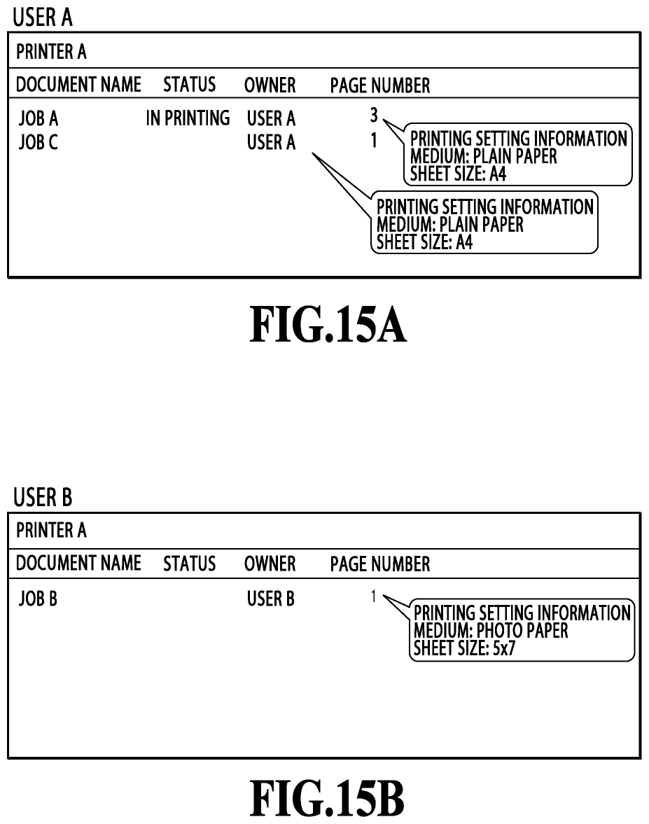

A specific example is illustrated in FIGS. 15A and 15B. First, as illustrated in FIG. 15A, the printing job of the job A of the user A of the PC 110A is transmitted to the printer 120, and the printer 120 is in the printing processing of the printing job of the job A. The printing setting information on the job A is “medium: plain paper, sheet size: A4”. A state where the job B is registered from the PC 110B, which is the PC different from the PC 110A, during the printing processing of the printing job of the job A of the user A is illustrated in FIG. 15B. Thereafter, the printing job of the job B is generated, and the printing job of the job B is transmitted to the printer 120. The printing setting information on the job B is “medium: photo paper, sheet size: 5×7”. Additionally, after the job B is registered, the job C of the user A illustrated in FIG. 15A is registered. In a case where all the printing jobs of the job A are transmitted to the printer 120, the job A is deleted from the printing queue 205A, the printing job of the job C is generated, the generated printing job of the job Cis transmitted to the printer 120. The printing setting information on the job C is “medium: plain paper, sheet size: A4”.

In a case of performing the processing described in the third embodiment with the example in FIGS. 15A and 15B, the printer 120 usually performs the printing processing in the order of received printing jobs, and thus the printing processing is performed in the order of job A->job B->job C. In this process, since the printing setting information between the job A and the job B do not match, the continuous feeding processing between printing jobs is not performed. Since the printing setting information between the job B and the job C do not match as well, the continuous feeding processing between printing jobs is not performed. However, since the printing setting information between the job A and the job C match, it is possible to execute the continuous feeding processing between printing jobs by performing the printing processing of the job C after the job A. Accordingly, it is possible to shorten the printing time more by performing the printing processing of the job C, not the job B, after the printing of the job A ends. In a fourth embodiment, a method of shortening the printing time by changing the processing order of the printing jobs to perform the continuous feeding processing between printing jobs in a case where there is a job in which the continuous feeding processing between printing jobs can be performed in the registered jobs is described.

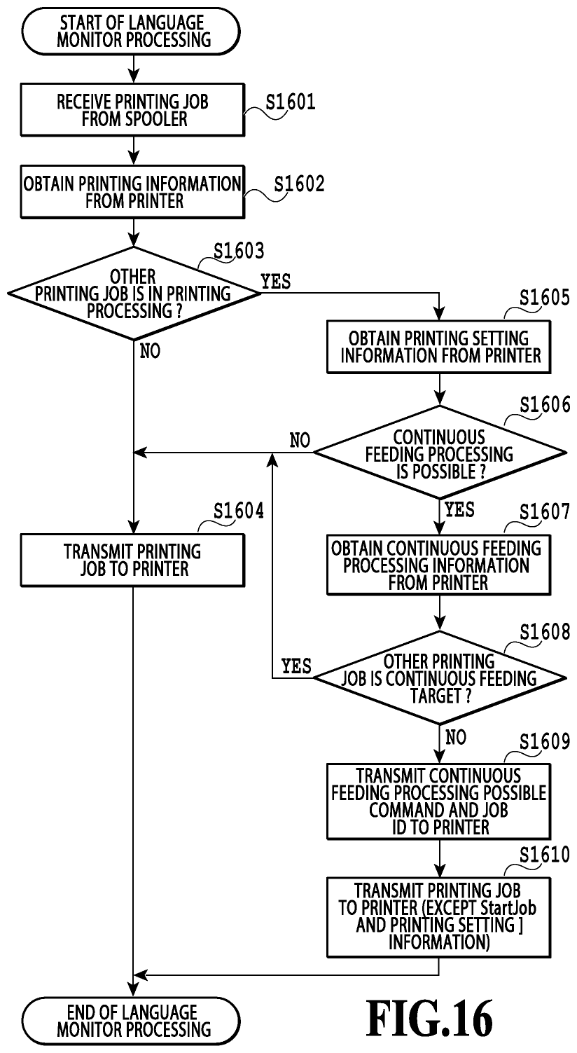

FIG. 16 is a flowchart illustrating a processing flow of the language monitor 208A of the PC 110A used by the user A in the fourth embodiment. Since processing from S1601 to S1606 is the same as the processing from S701 to S706 in FIG. 7, detailed description of the processing is omitted.

In S1606, the language monitor 208A determines whether the printer 120 is able to execute the continuous feeding processing between printing jobs. In a case where the language monitor 208A determines that the printer 120 is unable to execute the continuous feeding processing between printing jobs, the processing proceeds to S1604. In a case where the language monitor 208A determines that the printer 120 is able to execute the continuous feeding processing between printing jobs, the processing proceeds to S1607.

In S1604, the language monitor 208A transmits the generated printing job to the printer 120, and the processing flow illustrated in FIG. 16 is finished.

In S1607, the language monitor 208A obtains the continuous feeding processing information from the printer 120, and the processing proceeds to S1608. In the first embodiment, the language monitor 208 obtains the printing setting information from the printer 120. Based on the printing setting information, the language monitor 208 determines whether the printer 120 is able to execute the continuous feeding processing between printing jobs. Accordingly, the continuous feeding processing information is not used in the first embodiment. In contrast, in the fourth embodiment, the continuous feeding processing information is transmitted from the printer 120 to the language monitor 208A. The language monitor 208A, or the PC 110A, then determines whether the printer 120 is able to execute the continuous feeding processing between printing jobs based on the received continuous feeding processing information.

In S1608, based on the continuous feeding processing information obtained from the printer 120, the language monitor 208A confirms whether the other printing job is a target of the continuous feeding processing between printing jobs. In a case where the continuous feeding processing information does not indicate “perform continuous feeding processing between printing jobs”, the language monitor 208A determines that the other printing job is not the target of the continuous feeding processing between printing jobs. In a case where the other printing job is the target of the continuous feeding processing between printing jobs, the processing proceeds to S1604, and the language monitor 208A transmits the generated printing job to the printer 120. Then, the processing flow illustrated in FIG. 16 is finished. In a case where the other printing job is not the target of the continuous feeding processing between printing jobs, the processing proceeds to S1609.

In S1609, the language monitor 208A transmits the continuous feeding processing possible command and a job ID to the printer 120, and the processing proceeds to S1610.

In S1610, the language monitor 208A transmits the printing job from which the StartJob command and the printing setting information are deleted to the printer 120, and the processing flow illustrated in FIG. 16 is finished.

The processing flow illustrated in FIG. 16 is described specifically by using the example illustrated in FIGS. 15A and 15B.

First, the language monitor 208A of the PC 110A obtains the printing information from the printer 120 in S1602, and the processing proceeds to S1603. In S1603, the language monitor 208A obtains the information indicating that the printer 120 is not in the printing processing of the other printing job, and thus the processing proceeds to S1604. In S1604, the language monitor 208A transmits the job A to the printer 120. The printer 120 that receives the job A executes the printing processing of the job A.

Next, the language monitor 208B of the PC 110B tries to transmit the job B to the printer 120. In S1602, the language monitor 208B obtains the printing information from the printer 120, and the processing proceeds to S1603. In S1603, the language monitor 208B obtains the information indicating that the printer 120 is in the printing processing of the job A, and the processing proceeds to S1605. In S1605, the language monitor 208B obtains the printing setting information on the job A from the printer 120, and the processing proceeds to S1606. In S1606, since the printing setting information on the job A and the printing setting information on the job B are different, the language monitor 208B determines that it is unable to execute the continuous feeding processing between printing jobs, and the processing proceeds to S1604. In S1604, the language monitor 208B transmits the job B, and the language monitor 208B ends the processing in FIG. 16.

Additionally, the language monitor 208A of the PC 110A tries to transmit the job C to the printer 120. In S1602, the language monitor 208A obtains the printing information from the printer 120, and the processing proceeds to S1603. In S1603, the language monitor 208A obtains the information indicating that the printer 120 is in the printing processing of the job A, and the processing proceeds to S1605. In S1605, the language monitor 208A obtains the printing setting information on the job B from the printer 120, and the processing proceeds to S1606. In S1606, since the printing setting information on the job A and the printing setting information on the job C are the same, the language monitor 208A determines that it is possible to execute the continuous feeding processing between printing jobs on the job A and the job C, and the processing proceeds to S1607. In S1607, the language monitor 208A obtains the continuous feeding processing information on the other printing job from the printer 120, and the processing proceeds to S1608. In S1608, the language monitor 208A determines that the job B as the other printing job is not the target of the continuous feeding processing based on the printer 120 and executes the processing in S1609 and the processing in S1610. Then, the processing in FIG. 16 is finished.

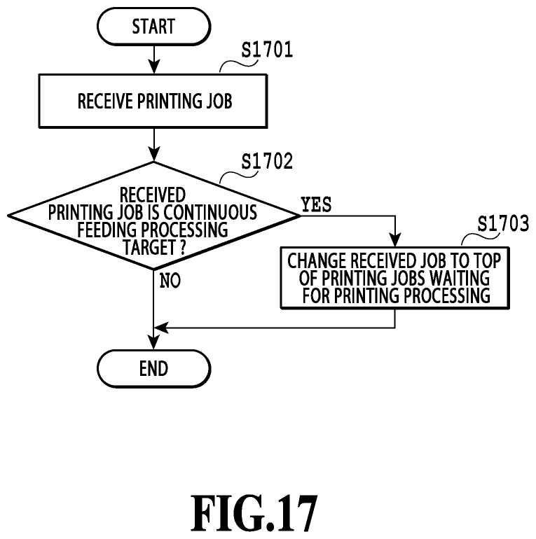

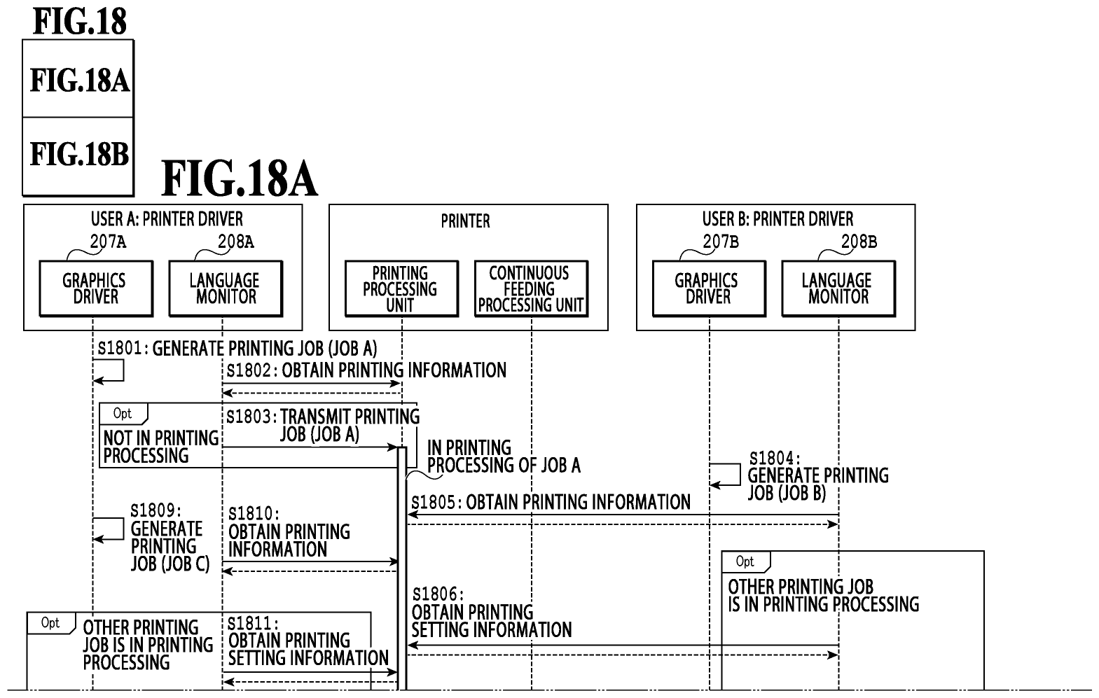

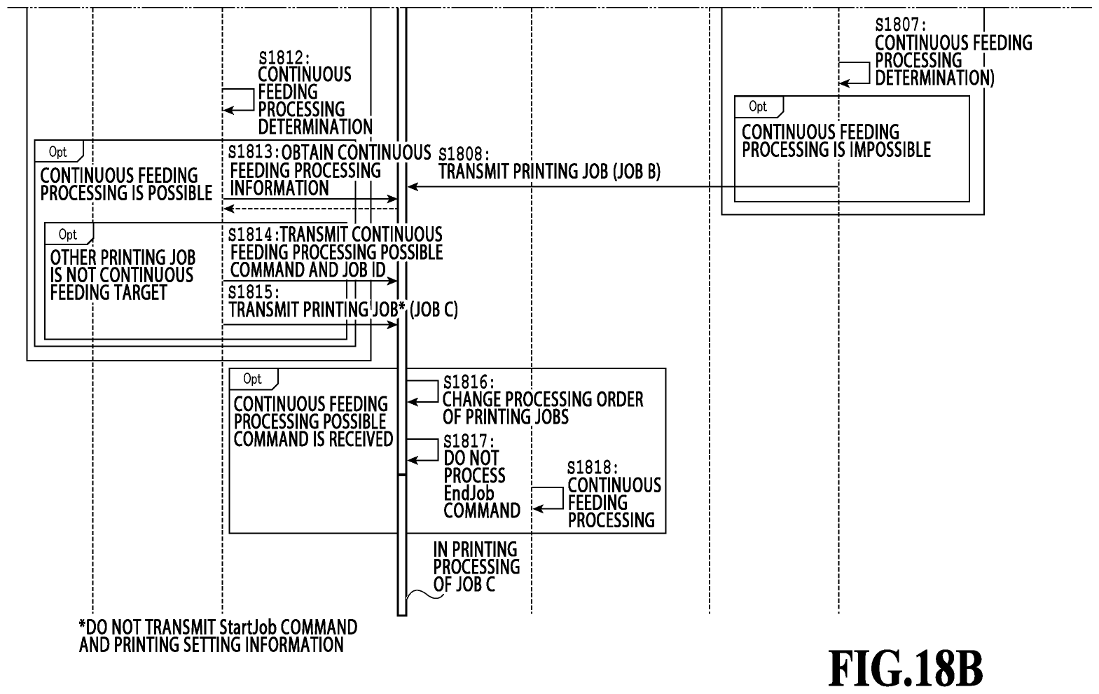

Specific control on whether to change the printing processing order is described in descriptions of a flowchart in FIG. 17 and sequence charts in FIGS. 18A and 18B as follows.

FIG. 17 is a flowchart illustrating a processing flow related to the control of the printing processing order of the printer 120.

In S1701, in a case where the printer 120 receives the printing job, the processing proceeds to S1702.

In S1702, the printer 120 determines whether the received printing job is the target of the continuous feeding processing between printing jobs. Specifically, in a case where the continuous feeding processing information indicates that the continuous feeding processing between printing jobs is to be performed and also in a case where the job ID is the received printing job, the printer 120 determines that the received printing job is the target of the continuous feeding processing between printing jobs. In a case where the printer 120 determines that the received printing job is the target of the continuous feeding processing between printing jobs, the processing proceeds to S1703. In a case where the printer 120 determines that the received printing job is not the target of the continuous feeding processing between printing jobs, the processing flow illustrated in FIG. 17 ends without the printer 120 changing the order of the printing processing waiting-printing jobs.

In S1703, the printer 120 changes the received printing job to the top of the printing processing waiting-printing jobs, and the processing flow illustrated in FIG. 17 is finished.

FIGS. 18A and 18B are sequence charts illustrating a processing flow to perform the continuous feeding processing between printing jobs in an example of the printing queues 205 of the users in FIGS. 15A and 15B by using the processing flow of the fourth embodiment described in FIGS. 16 and 17. Since processing from S1801 to S1807 is the same as the processing from S1401 to S1407 illustrated in FIGS. 14A and 14B, detailed description of the processing is omitted.

In S1807, the language monitor 208B determines whether the printer 120 is able to execute the continuous feeding processing between printing jobs. The printing setting information on the printing job in the printing processing is “medium: plain paper, sheet size: A4”, and the printing setting information on the job B is “medium: photo paper, sheet size: 5×7”. Since the printing setting information on the printing jobs do not match, the language monitor 208B determines that the printer 120 is unable to execute the continuous feeding processing between printing jobs, and the processing proceeds to S1808.

In S1808, since it is determined that the printer 120 is unable to execute the continuous feeding processing, the language monitor 208B transmits the printing job including the StartJob command and the printing setting information to the printer 120.

On the other hand, in an environment of the user A, after the printing job of the job A is transmitted to the printer 120 in S1803, the processing proceeds to S1809.

In S1809, the graphics driver 207A generates the printing job of the job C, and the processing proceeds to S1810.

In S1810, the language monitor 208A obtains the printing information from the printer 120. In a case where the printer 120 is requested the printing information from the language monitor 208A, the printer 120 returns whether it is in the printing processing to the language monitor 208A. In the fourth embodiment, since the printer 120 is in the printing processing of the printing job of the job A, the printer 120 returns “in printing processing” to the language monitor 208A, and the processing proceeds to S1811.

In S1811, since the obtained printing information is in the printing processing and also the printing job of the job C is not in the printing processing, the language monitor 208A determines that the printer 120 is in the printing processing of the other printing job. The language monitor 208A then obtains the printing setting information from the printer 120, and the processing proceeds to S1812.

In S1812, based on the obtained printing setting information, the language monitor 208A determines whether the printer 120 is able to execute the continuous feeding processing between printing jobs. The obtained printing setting information and the printing setting information on the job C are “medium: plain paper, sheet size: A4”. Since the two pieces of information match, the language monitor 208A determines that the printer 120 is able to execute the continuous feeding processing between printing jobs, and the processing proceeds to S1813.

In S1813, the language monitor 208A obtains the continuous feeding processing information from the printer 120 and confirms whether the other job is the target of the continuous feeding processing between printing jobs. In a case where the printer 120 is requested the continuous feeding processing information, the printer 120 returns to the language monitor 208A the information on whether to perform the continuous feeding processing between printing jobs on the next printing job, and in a case where the continuous feeding processing between printing jobs is performed, the printer 120 also returns to the language monitor 208A the continuous feeding processing information on the job ID of the printing job on which the continuous feeding processing is to be performed. The job ID is an ID uniquely indicating the printing job. In a case of the fourth embodiment, since the printer 120 does not receive the continuous feeding processing possible command and the job ID, the printer 120 returns “do not perform continuous feeding processing” to the language monitor 208A, and the processing proceeds to S1814.

In S1814, in a case where the language monitor 208A receives the information indicating “do not perform continuous feeding processing” from the printer 120, the language monitor 208A determines that the other job is not the continuous feeding target. The language monitor 208A then transmits the continuous feeding processing possible command and the job ID to the printer 120, and the processing proceeds to S1815. The job ID may be anything as long as it is an ID uniquely indicating the printing job and may be, for example, a document name of the printing queue 205. In the fourth embodiment, “job C” that is the document name is transmitted as the job ID. Since the printer 120 receives the continuous feeding processing possible command and the job ID from the language monitor 208A, in a case of being requested the continuous feeding processing information from one PC, the printer 120 returns the continuous feeding processing information including the information indicating “perform continuous feeding processing” and information indicating that the job ID is “job C” to the PC.

In S1815, after the language monitor 208A transmits the continuous feeding processing possible command and the job ID to the printer 120, the language monitor 208A transmits the printing job of the job C from which the StartJob command and the printing setting information are deleted to the printer 120. The processing then proceeds to S1816. To make sure, before the printing job transmission, the language monitor 208A may obtain the continuous feeding processing information from the printer 120 again to confirm whether the information indicating “perform continuous feeding processing” and the information indicating that the job ID is “job C” are obtained.

In S1816, after receiving the printing job of the job C from which the StartJob command and the printing setting information are deleted, the printer 120 changes the processing order of the printing jobs, and the processing proceeds to S1817.

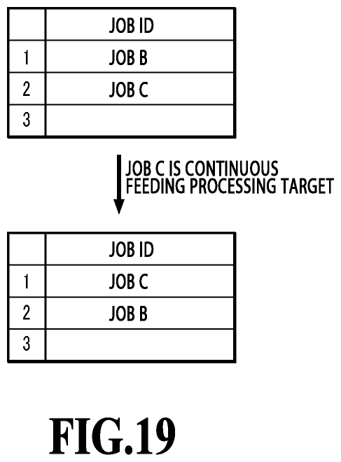

FIG. 19 is a diagram illustrating a change in the processing order of the printing jobs. At the time of receiving the job C, since the printing job of the job B is already received in S1808, the printer 120 waits for the printing processing in the order of job B->job C. After receiving the job C, the printer 120 confirms whether the job C is the target of the continuous feeding processing between printing jobs based on the continuous feeding processing information. Since the job C is the target of the continuous feeding processing between printing jobs, the printer 120 changes the job C to the top of the printing processing waiting-printing jobs. In other words, the order of the job B and the job C is changed into job C->job B.

In S1817, the processing proceeds to S1818 without the printer 120 performing the processing of the EndJob command of the job A in the printing processing.

In S1818, the printer 120 performs the continuous feeding processing between printing jobs, and after the printing processing of the job A ends, the printing processing of the job C, not the job B, is started.

As described above, with the printer 120 changing the order of the jobs waiting for the printing processing in a case where it is possible to perform the continuous feeding processing between printing jobs on the job received later, it is possible to perform the continuous feeding processing between printing jobs, and it is possible to shorten the printing time.

In the fourth embodiment, before the language monitor 208B transmits the printing job to the printer 120, the language monitor 208B compares the printing setting information between the printing job and the printing job currently in the printing processing and determines whether the continuous feeding processing between printing jobs is possible.

In a case where it is impossible to perform the continuous feeding processing between printing jobs, the language monitor 208B transmits the generated printing job to the printer 120 without issuing the continuous feeding processing possible command. Thereafter, at the time of transmitting the printing job on which it is possible to perform the continuous feeding processing from the language monitor 208A to the printer 120, the order of the printing jobs waiting for the printing processing is changed, and the printing processing of the printing job transmitted later starts first.

In some cases, the continuous feeding processing between printing jobs becomes possible by comparing the printing setting information on the printing job waiting for the printing processing with the printing setting information on the printing job and. In this case, as illustrated in the second embodiment, the determination on whether the printer 120 is able to perform the continuous feeding processing between printing jobs may be made. In a case where it is determined that the printer 120 is able to perform the continuous feeding processing between printing jobs, the printer 120 changes the order of the printing jobs waiting for the printing processing and performs the continuous feeding processing between printing jobs.

Additionally, if it is determined that it is too late for the continuous feeding processing between printing jobs even if the printer 120 receives the continuous feeding processing possible command, the printer 120 may perform normal printing processing without performing the continuous feeding processing between printing jobs.

### Fifth Embodiment

In the fourth embodiment, a method in which, in a case where there is the printing job on which it is possible to perform the continuous feeding processing between printing jobs, it is possible to perform the continuous feeding processing between printing jobs with the printer 120 changing the order of the printing jobs waiting for the printing processing, and it is possible to shorten the printing time is described.

However, in this method, since the order of executing the printing processing is switched even though the printing of the printing job in which it is impossible to perform the continuous feeding processing is executed first on the PC, there occurs a problem that the printing of the printing job in which it is impossible to perform the continuous feeding processing is postponed.

For example, the example of FIGS. 15A and 15B described in the fourth embodiment is a case where, even though the user B executes the printing of the job B on the PC earlier than the job C, the job C of the user A that is determined that it is possible to perform the continuous feeding processing between printing jobs thereon is printed first. The postponed user B may be discontent. In some cases, it is more important to maintain the order of the processing of the printing jobs than shortening the printing time by prioritizing the continuous feeding processing between printing jobs. It is more optimal to allow switching between whether to prioritize the continuous feeding processing between printing jobs or to prioritize the maintenance of the order of the processing of the printing jobs depending on the situation.

In a fifth embodiment, a method of allowing the user to set whether to prioritize the continuous feeding processing between printing jobs or to prioritize the maintenance of the order of the processing of the printing jobs is described.

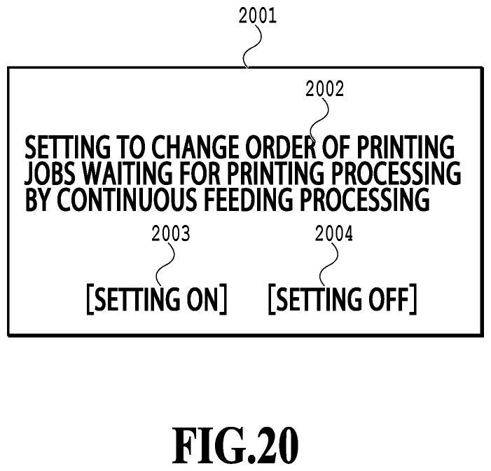

FIG. 20 illustrates an example of a method of allowing the user to set whether to prioritize the continuous feeding processing between printing jobs or to prioritize the maintenance of the order of the processing of the printing jobs. A display unit 2001 is a display panel mounted in the printer 120. In the fifth embodiment, the display unit 2001 is described as a touch display panel. However, the display unit 2001 is not limited to this. The display unit 2001 includes a function name display region 2002 of the function to be set and displays a function name of the setting whether to prioritize the continuous feeding processing between printing jobs or to prioritize the maintenance of the order of the processing of the printing jobs. A setting ON button 2003 and a setting OFF button 2004 are arranged below the function name display region 2002. In a case where the setting ON button 2003 is touched, the setting displayed in the function name display region 2002 is set to ON. In a case where the setting OFF button 2004 is touched, the setting displayed in the function name display region 2002 is set to OFF.

In a case of the fifth embodiment, in a case where the setting ON button 2003 is touched, the setting to prioritize the continuous feeding processing is applied. This setting allows changing of the order of the printing jobs waiting for the printing processing. In a case where the setting OFF button 2004 is touched, the setting to preferentially maintain the order of the processing of the printing jobs is applied. This setting does not allow execution of the continuous feeding processing between printing jobs.

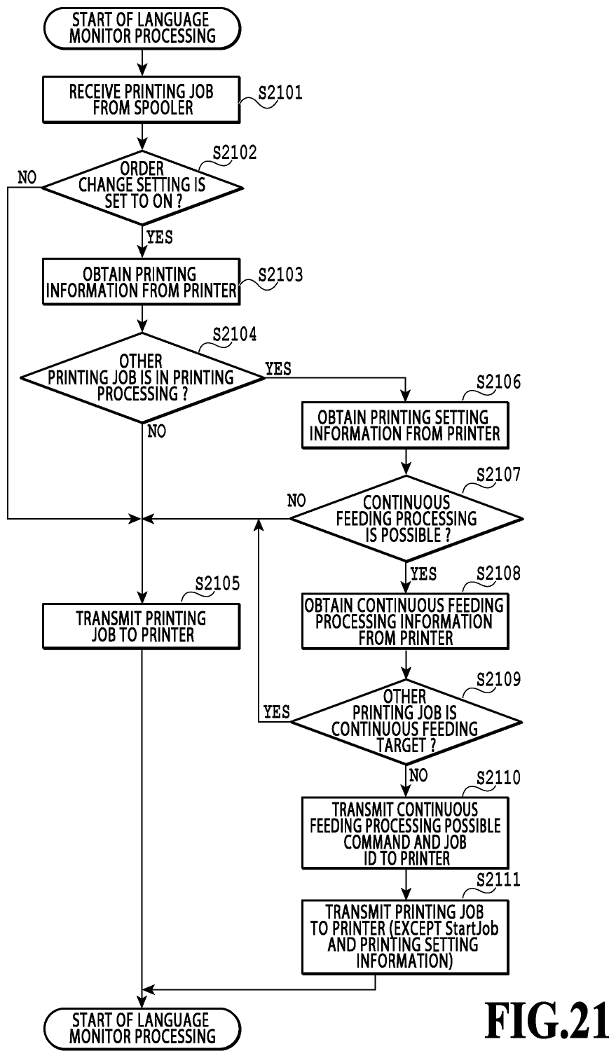

FIG. 21 is a flowchart illustrating a processing flow of the language monitor 208 of the fifth embodiment.

In S2101, the language monitor 208 receives the printing job generated by the graphics driver 207 from the spooler 204. In a case where the language monitor 208 receives the printing job, the processing proceeds to S2102.

In S2102, in a case where receiving the printing job from the printer 120 in S2101, as illustrated in FIG. 20, the language monitor 208 confirms whether the setting allows the user to prioritize the continuous feeding processing between printing jobs or to prioritize the maintenance of the order of the processing of the printing jobs.

In S2102, in a case where the setting is ON, or in a case where the setting to prioritize the continuous feeding processing between printing jobs and to change the order of the printing jobs waiting for the printing processing is applied, the processing indicated from S2103 to S2111 is performed, and the processing flow illustrated in FIG. 21 is finished. The processing from S2103 to S2111 is the same as the processing indicated from S1602 to S1610 in FIG. 16; for this reason, description is omitted.

In S2102, in a case where the setting is OFF, or in a case where the setting to prioritize the maintenance of the order of the processing of the printing jobs and to not execute the continuous feeding processing between printing jobs is applied, the processing proceeds to S2105. In S2105, the language monitor 208 transmits the generated printing job to the printer 120, and the processing flow illustrated in FIG. 21 is finished.

Allowing the user to set whether to prioritize the continuous feeding processing between printing jobs or to prioritize the maintenance of the order of the processing of the printing job, it is possible to appropriately switch the setting of the printer according to the processing method that the user wants to prioritize.

Additionally, if it is determined that it is too late for the continuous feeding processing between printing jobs even if the printer 120 receives the continuous feeding processing possible command, the printer 120 may perform normal printing processing without performing the continuous feeding processing between printing jobs.

### Sixth Embodiment

In the first to fifth embodiments, there is a demerit that the printer 120 needs a high-capacity buffer to hold the printing jobs.

For example, in a case of the printing queue illustrated in FIG. 4, after the printing job of the job A is deleted from the printing queue, the graphics driver 207 generates the printing job of the job B, and thereafter the language monitor 208 makes the determination on the continuous feeding processing between printing jobs. In this process, in order to delete the printing job of the job A from the printing queue, the language monitor 208 needs to complete the transmission of the printing job of the job A to the printer 120. In other words, if the capacity of the buffer to hold the printing jobs of the printer 120 is small, completion of the transmission of the printing job of the job A is slow.

However, there is a tendency that a relatively inexpensive printer does not include a buffer with a capacity to store a large amount of the printing jobs, and such a buffer of the printer cannot store all the printing jobs. In a case of such a printer, first, the printer receives a part of the printing jobs corresponding to the buffer capacity. After the processing of the received printing job ends, the operation to receive a part of the rest of the printing jobs corresponding to the buffer capacity is repeated again until receiving all the printing jobs. Depending on the size of the buffer capacity of the printer, in a case of the printing queue of FIG. 4, the job A may remain until a moment just before ending the printing of the job A. In other words, in a case where the transmission of the printing job of the job A is completed, and the job A is deleted, the generation of the printing job of the job B is started. Accordingly, even in a case where it is determined that the continuous feeding processing between printing jobs is possible, the printing processing of the job A may proceed to the degree it is too late to perform the continuous feeding processing between printing jobs. In this case, even under the condition that the continuous feeding processing between printing jobs is possible, the continuous feeding processing between printing jobs is not performed. In the sixth embodiment, a method of allowing for the continuous feeding processing between printing jobs even in the printer that does not include the buffer that can hold all the printing jobs.

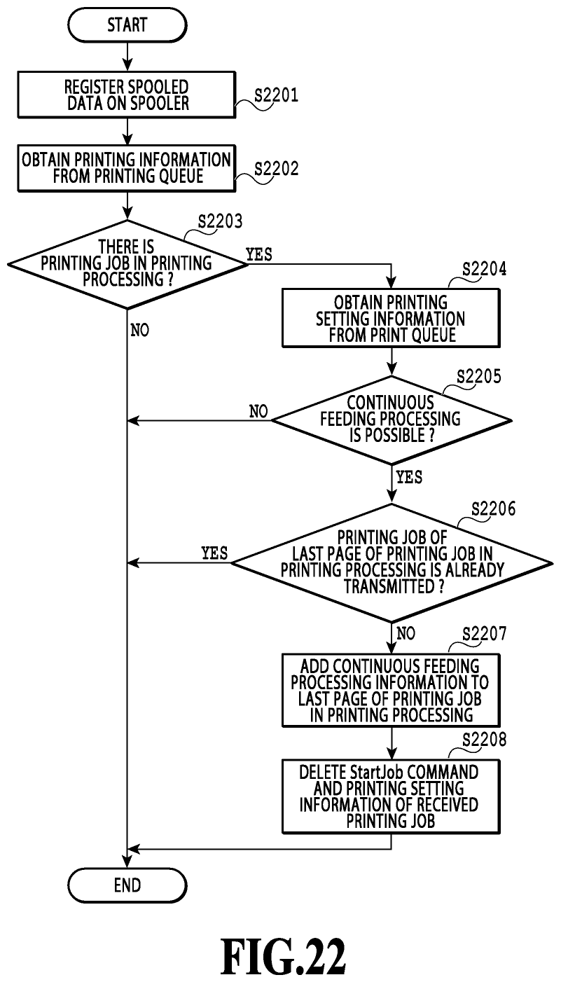

FIG. 22 is a flowchart illustrating the continuous feeding determination processing flow of the language monitor 208 of the sixth embodiment.

In S2201, the spooled data 206 is registered on the spooler 204, and the processing proceeds to S2202.

In S2202, the printing information indicating whether there is the printing job in the printing processing is obtained from the printing queue 205, and the processing proceeds to S2203.

In S2203, if there is no printing job in the printing processing in the printing queue 205, the processing flow illustrated in FIG. 22 ends. In a case where there is the printing job in the printing processing in the printing queue 205, the processing proceeds to S2204.

In S2204, the language monitor 208 obtains the printing setting information on the printing job in the printing processing and the printing setting information on the spooled data registered in S2201 from the printing queue 205, and the processing proceeds to S2205.

In S2205, the language monitor 208 compares the obtained printing setting information and determines whether it is possible to perform the continuous feeding processing between printing jobs. In a case where the language monitor 208 determines that the continuous feeding processing between printing jobs is impossible, the processing flow illustrated in FIG. 22 ends. In a case where the language monitor 208 determines that the continuous feeding processing between printing jobs is possible, the processing proceeds to S2206.

In S2206, the language monitor 208 confirms whether the printing job of the last page of the printing job in the printing processing is already transmitted. In a case where the language monitor 208 determines that the printing job of the last page is already transmitted, the language monitor 208 determines that it is impossible to perform the continuous feeding processing between printing jobs, and the processing flow illustrated in FIG. 22 is finished. In a case where the language monitor 208 determines that the printing job of the last page is not transmitted yet, the language monitor 208 determines that it is possible to perform the continuous feeding processing between printing jobs, and the processing proceeds to S2207.

In S2207, the language monitor 208 adds the continuous feeding processing information to the printing job of the last page of the printing job in the printing processing, and the processing proceeds to S2208. Thus, it is possible to instruct the printer 120 to perform the continuous feeding processing at the time of transmitting the printing job of the last page to the printer 120.

In S2208, the printing job of the received spooled data is generated. At the time of transmitting the printing job by the language monitor 208, the language monitor 208 transmits the printing job from which the StartJob command and the printing setting information are deleted to the printer 120, and the processing flow illustrated in FIG. 22 is finished.

The language monitor 208 compares the printing setting information on the printing job in the printing processing and the printing setting information on the registered spooled data from the printing queue and determines whether it is possible to perform the continuous feeding processing between printing jobs. Thus, it is possible to perform the continuous feeding processing between printing jobs even in the printer that does not include the buffer that can hold all the printing jobs.

In the sixth embodiment, the processing of adding the continuous feeding processing information to the printing job of the last page of the printing job in the printing processing is described. As with the first embodiment, the above-described function is implemented also by the language monitor 208 transmitting the continuous feeding processing possible command to the printer 120.

Additionally, the sixth embodiment may be executed in combination with the first embodiment, the third embodiment, the fourth embodiment, or the fifth embodiment.

### Other Embodiments

Embodiment(s) of the present disclosure is able to also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-118175, filed Jul. 25, 2022, which is hereby incorporated by reference wherein in its entirety.

What is claimed is:

1. An information processing apparatus that can communicate with an image forming apparatus, comprising:
at least one memory and at least one processor and/or at least one circuit which function as:
a reception unit configured to receive printing setting information used for printing processing of a current printing job that is currently running in the image forming apparatus;
an obtainment unit configured to obtain a subsequent printing job registered on a printing queue; and
a control unit configured to transmit a subsequent printing job, without a printing processing start command and printing setting information, corresponding to the obtained subsequent printing job, to the image forming apparatus in a case where it is possible to perform continuous printing processing in the image forming apparatus based on printing setting information on the received current printing job and printing setting information on the obtained subsequent printing job.

2. The information processing apparatus according to claim 1, wherein
the printing setting information includes a type of sheet and a sheet size.

3. The information processing apparatus according to claim 1, wherein
the continuous printing processing is to feed a medium of the subsequent printing job while the image forming apparatus is printing a last page of the printing processing of the current printing job.

4. The information processing apparatus according to claim 1, wherein,
in a case where the reception unit receives information of setting to allow execution of the continuous printing processing from the image forming apparatus and also it is possible to perform the continuous printing processing in the image forming apparatus, the control unit transmits the subsequent printing job without the printing processing start command and the printing setting information to the image forming apparatus.

5. The information processing apparatus according to claim 1, wherein,
in a case where the reception unit receives information of setting to not allow execution of the continuous printing processing from the image forming apparatus, the control unit does not transmit the subsequent printing job without the printing processing start command and the printing setting information to the image forming apparatus.

6. A control method for an information processing apparatus that can communicate with an image forming apparatus, the control method comprising:
receiving printing setting information used for printing processing of a current printing job that is currently running in the image forming apparatus;
obtaining a subsequent printing job registered on a printing queue; and
transmitting a subsequent printing job, without a printing processing start command and printing setting information, corresponding to the obtained subsequent printing job, to the image forming apparatus in a case where it is possible to perform continuous printing processing in the image forming apparatus based on printing setting information on the received current printing job and printing setting information on the obtained subsequent printing job.

7. A non-transitory computer readable storage medium storing a program for causing a computer to perform a control method for an information processing apparatus that can communicate with an image forming apparatus, the control method comprising:
receiving printing setting information used for printing processing of a current printing job that is currently running in the image forming apparatus;
obtaining a subsequent printing job registered on a printing queue; and
transmitting a subsequent printing job, without a printing processing start command and printing setting information, corresponding to the obtained subsequent printing job, to the image forming apparatus in a case where it is possible to perform continuous printing processing in the image forming apparatus based on printing setting information on the received current printing job and printing setting information on the obtained subsequent printing job.

8. An image forming apparatus that can communicate with an information processing apparatus, comprising:
at least one memory and at least one processor and/or at least one circuit which function as:
a reception unit configured to receive a printing job from the information processing apparatus; and
a printing control unit configured to perform continuous printing processing on the received printing job in a case where the reception unit receives a printing job without a printing processing start command and printing setting information.

9. The image forming apparatus according to claim 8, wherein
the continuous printing processing is to feed a medium of a next printing job while printing a last page of printing processing of a current printing job.

10. The image forming apparatus according to claim 8, wherein the at least one memory and the at least one processor and/or the at least one circuit further function as:
a setting unit that sets whether to allow or to not allow execution of the continuous printing processing.

11. The image forming apparatus according to claim 10, wherein,
in a case where the setting unit performs setting to allow execution of the continuous printing processing, and also the reception unit receives a printing job without a printing processing start command and printing setting information, the printing control unit performs the continuous printing processing.

12. The image forming apparatus according to claim 10, wherein,
in a case where the setting unit performs setting to not allow execution of the continuous printing processing, the printing control unit does not perform the continuous printing processing.

13. A control method for an image forming apparatus that can communicate with an information processing apparatus, the control method comprising:
receiving a printing job from the information processing apparatus; and
performing continuous printing processing on the received printing job in a case where a printing job without a printing processing start command and printing setting information is received.

14. A non-transitory computer readable storage medium storing a program for causing a computer to perform a control method for an image forming apparatus that can communicate with an information processing apparatus, the control method comprising:
receiving a printing job from the information processing apparatus; and
performing continuous printing processing on the received printing job in a case where a printing job without a printing processing start command and printing setting information is received.

15. An image forming apparatus that can communicate with an information processing apparatus, comprising:
at least one memory and at least one processor and/or at least one circuit which function as:
a reception unit configured to receive a printing job from the information processing apparatus; and
a printing control unit configured to perform continuous printing processing on the received printing job in a case where it is possible to perform the continuous printing processing based on printing setting information on a current printing job and printing setting information on the received printing job.

16. The image forming apparatus according to claim 15, wherein
the printing setting information includes a type of sheet and a sheet size.

17. The image forming apparatus according to claim 15, wherein
the continuous printing processing is to feed a medium of a next printing job while printing a last page of printing processing of the current printing job.

18. The image forming apparatus according to claim 15, wherein
the continuous printing processing is to not execute processing of a printing processing end command of the current printing job.

19. The image forming apparatus according to claim 15, wherein the at least one memory and the at least one processor and/or the at least one circuit further function as:
a setting unit that sets whether to allow or to not allow execution of the continuous printing processing.

20. The image forming apparatus according to claim 19, wherein,
in a case where the setting unit performs setting to allow execution of the continuous printing processing, and also the reception unit receives a printing job without a printing processing start command and printing setting information, the printing control unit performs the continuous printing processing.

21. The image forming apparatus according to claim 19, wherein,
in a case where the setting unit performs setting to not allow execution of the continuous printing processing, the printing control unit does not perform the continuous printing processing.

22. A control method for an image forming apparatus that can communicate with an information processing apparatus, the control method comprising:
receiving a printing job from the information processing apparatus; and
performing continuous printing processing on the received printing job in a case where it is possible to perform the continuous printing processing based on printing setting information on a current printing job and printing setting information on the received printing job.

23. A non-transitory computer readable storage medium storing a program for causing a computer to perform a control method for an image forming apparatus that can communicate with an information processing apparatus, the control method comprising:
receiving a printing job from the information processing apparatus; and
performing continuous printing processing on the received printing job in a case where it is possible to perform the continuous printing processing based on printing setting information on a current printing job and printing setting information on the received printing job.

24. An image forming system, comprising:
an information processing apparatus; and
an image forming apparatus that can communicate with the information processing apparatus, wherein
the information processing apparatus comprises:
at least one memory and at least one processor and/or at least one circuit which function as:
a reception unit configured to receive printing setting information used for printing processing of a current printing job that is currently running in the image forming apparatus from the image forming apparatus;
an obtainment unit configured to obtain a subsequent printing job registered on a printing queue; and
a control unit configured to transmit a subsequent printing job, without a printing processing start command and printing setting information, corresponding to the obtained subsequent printing job, to the image forming apparatus in a case where it is possible to perform continuous printing processing in the image forming apparatus based on printing setting information on the received current printing job and printing setting information on the obtained subsequent printing job, and
the image forming apparatus comprises:
at least one memory and at least one processor and/or at least one circuit which function as:
a reception unit configured to receive a printing job from the information processing apparatus; and
a printing control unit configured to perform the continuous printing processing on the received printing job in a case where the reception unit receives the printing job without the printing processing start command and the printing setting information.

25. An image forming system, comprising:
an information processing apparatus; and
an image forming apparatus that can communicate with the information processing apparatus, wherein
the information processing apparatus comprises:
at least one memory and at least one processor and/or at least one circuit which function as:
a transmission unit configured to transmit a printing job to the image forming apparatus, and
the image forming apparatus comprises:
at least one memory and at least one processor and/or at least one circuit which function as:
a reception unit configured to receive a printing job from the information processing apparatus; and
a printing control unit configured to perform continuous printing processing on the received printing job in a case where it is possible to perform the continuous printing processing based on printing setting information on a current printing job and printing setting information on the received printing job.
